(19) United States
(12) Patent Application Publication
(10) Pub. No.: US 2013/0068631 A1
(43) Pub. Date: Mar. 21, 2013

(54) METHOD AND APPARATUS FOR SANITIZING WATER IN A BATHING UNIT AND CONTROL INTERFACE FOR USE IN CONNECTION WITH SAME

(71) Applicants: Christian Brochu, Quebec (CA); Francois Lapierre, Quebec (CA)

(72) Inventors: Christian Brochu, Quebec (CA); Francois Lapierre, Quebec (CA)

(73) Assignee: GECKO ALLIANCE GROUP INC., Quebec (CA)

(21) Appl. No.: 13/699,252

(22) PCT Filed: May 21, 2010
(86) PCT No.: PCT/CA2010/000774

§ 371 Date: Nov. 20, 2012

(51) Int. Cl. C02F 1/467; G05F 5/00; C02F 1/461

(52) U.S. Cl. CPC C02F 1/467; C02F 1/46104; G05F 5/00
USPC 205/743; 204/228.1; 700/295

(57) ABSTRACT

A sanitizing system is provided for use in a bathing unit system including a receptacle for holding water in which a halide salt has been dissolved and a circulating system for removing and returning water from and to the receptacle. The sanitizing system includes a sanitizing device having a housing configured to be positioned in fluid communication with the circulation system and an electrolytic cell positioned within the housing so that when power is applied to the electrolytic cell, the halide salt dissolved in water flowing through the housing is converted to an amount of free halogen. A controller controls an amount of power supplied to the electrolytic cell so as to control the amount of free halogen being generated. The amount of power supplied may be adjusted, for example, based on an amount of usage of the bathing unit system, a usage of a circulation pump and/or based on a water temperature. A user control interface for the sanitizing device is also provided.

### FIELD OF THE INVENTION

The present invention relates to the field of bathing units, and more specifically, to methods and devices for sanitizing water in bathing units such as hot tubs, spa and pools, using electrolytic cell assemblies.

### BACKGROUND

A bathing unit, such as a spa, typically includes various components used in the operation of the bathing unit system such as a water holding receptacle, pumps to circulate water in a piping system, a heating module to heat the water, a filter system, an air blower, a lighting system, and a control system for activating and managing the various parameters of the bathing unit components. The circulation system pumps water from the water holding receptacle through the filter system to maintain the body of water at sanitary conditions. In particular, the water passes through the filter system to reduce the accumulation of foreign material, such as hair, soil, or solids, in the pool or spa.

In addition to filtering, bathing unit systems also require regular sanitization in order to maintain hygienic conditions. Allowing sanitation levels to either fall below or rise above required specifications results in decreased efficiency of the system. Low levels of chemical sanitizer in the bathing unit can contribute to algae blooms, bacterial breakouts, cloudiness in the water, and chemical imbalances. If left untreated, water-borne bacteria can afflict users of the bathing units with a variety of health problems and illnesses, such as pseudomonas, rashes, hot tub lung, ear infections, etc.

Water sanitation is well known and long practiced. Typical sanitation regimens and processes rely on halogen treatment chemicals to provide disinfecting action. Halogens, and in particular free chlorine and bromine, have been the chemicals of choice for treating recreational reservoir water.

Conventional halogen sanitation regimens and processes for bathing units make use of tablets, liquids and powders that rely on a strict and continual maintenance regimen in order to function properly. Deviation due to forgetfulness or negligence can lower the availability of sanitizing halogen in the water reservoir and, as a consequence, compromise the fitness of the water. It is not uncommon, for example, for a spa (hot tub) owner to remove a floating apparatus containing brominating tablets from a spa prior to use, and then forget to return the apparatus to the spa after use. A day or more of missed sanitizing treatment can be sufficient to permit proliferation of microorganisms in the spa.

More recently, it has been known to equip swimming pools with “automatic” halogen generator cells. These automatic “electrolytic” cells usually cooperate with an already existing circulation system, such as a water filtration system comprising piping and a water pump. A salt, such as sodium chloride or sodium bromide, is added to the water reservoir to form a dissolved electrolyte in the water. The water carries the electrolyte through the circulation system and, consequently, through the electrolytic halogen generator cell installed in the circulation system. Electrodes in the halogen generator cell cause the salt to undergo electrolysis, which breaks the salt down into its basic elements, e.g., sodium and chlorine or sodium and bromine as the case may be. The re-circulation system then returns the water to the water reservoir with an enhanced chlorine (or bromine) level to provide sanitation and disinfecting action against bacteria, viruses, and algae. In doing so, the chlorine (or bromine) reverts back into its dissolved salt state for recycling and further use. This cycle is repeated multiple times.

Such electrolytic (halogen generator) cell assemblies are known in the art. Examples of electrolytic cell assemblies for use in spas and other bathing units have been described, for example, in U.S. Pat. No. 5,254,226, entitled “Electrolytic Cell Assembly for Production of Bromine”, which issued on Oct. 19, 1993 to Williams et al.; in U.S. Pat. No. 7,351,331, entitled “Recreational Spa Including a Bromine Generator”, which issued on Apr. 1, 2008 to Birkbeck; in U.S. Pat. No. 5,034,110, entitled “Pool Chlorinators” which issued on Jul. 23, 1991 to Glore et al.; in U.S. Pat. No. 6,821,398, entitled “Chlorination System for Swimming Pools and the Like”, which issued on Nov. 23, 2004 to Von Broembsen; in U.S. Pat. No. 6,059,942, entitled “Electrolytic Generation of Halogen Biocide”, which issued on May 9, 2000 to Barnes et al.; in U.S. Patent Publication US 2006/0283808, entitled “Automated Electrolyte addition for Salt Water Pools, Spas and Water features”, which was published on Dec. 21, 2006; and in U.S. Patent Publication US 2006/0097878, entitled “Chlorination System for Swimming Pools and the Like”, which was published on May 11, 2006. The contents of the aforementioned documents are incorporated herein by reference.

Generally speaking, the amount of halogen generated by such electrolytic cell assemblies is proportional to the amount of current between the electrodes of the electrolytic cell. The amount of halogen required for sanitizing water in a bathing unit is proportional to and depends in part on the amount of water and the amount of bacteria in the water.

A deficiency with existing halogen generator system is that they do not provide suitable manners for adapting the amount of halogen being generated so as to maintain a desired level of halogen in the water in the presence of varying levels of bacteria.

Another deficiency of conventional halogen generator system is that they do not provide a suitable mechanism for allowing a user to easily determine how much halide salt should be added to a bathing unit in order to achieve a suitable level of halogen generation in the bathing unit. More specifically, to be effective, electrochemical generation of halogen typically requires the concentration of halide salt to be maintained within a specified range to efficiently produce the halogen (chlorine or bromine for example). Maintaining a suitable concentration of the halide salt in the bathing unit typically requires the user to perform periodic measurements of the total dissolved solids (TDS) in the water for example by using a water testing kit and to add an amount of salt depending of the results of such tests. The amount of salt added is often approximated by the user. Typically the guidelines are given in terms of an amount of halide salt to add for a certain volume of water. A trial and error approach is typically used to achieve a desired result whereby successive measurements of the total dissolved solids (TDS) properties of the water are taken following the addition of an amount of halide salt. This is a lengthy process which often results in frustration on the part of the user.

Another deficiency associated with conventional halogen generator systems is that they do not provide a suitable manner for detecting a malfunction of associated with the halogen generation.

Against the background described above, it appears that there is a need in the industry to provide a method and apparatus for use in sanitizing water in a bathing unit system that alleviates at least in part the problems associated with existing systems.

### SUMMARY

In accordance with a broad aspect, the invention related to a sanitizing system for use in sanitizing water in a bathing unit system. The bathing unit system includes a receptacle for holding water in which an halide salt has been dissolved and a circulating system for removing and returning water from and to the receptacle. The sanitizing system comprises a sanitizing device including a housing configured to be positioned in fluid communication with the circulation system for allowing water from the receptacle to flow through the housing. The sanitizing device also comprises an electrolytic cell positioned within the housing so that when power is applied to the electrolytic cell, the halide salt dissolved in the water flowing through the housing is converted to an amount of free halogen. The sanitizing system also comprises a controller configured for controlling an amount of power supplied to the electrolytic cell of the sanitizing device so as to control the amount of free halogen being generated. The controller adjusts the amount of power supplied to the electrolytic cell at least in part based on use of the bathing unit system.

In accordance with a specific example, the amount of power supplied to the electrolytic cell is adjusted at least in part based on an amount of use of the bathing unit system. The controller receives data conveying bathing unit usage information and adjusts the amount of power supplied to the electrolytic cell at least in part based on the received bathing unit usage information so as to adjust the amount of free halogen generated based in part on the amount of use of the bathing unit system. In non-limiting implementations, the bathing unit usage information may convey a number of bathers using the bathing unit system or the activation of a comfort bathing unit module in the bathing unit system (such as for example a (jet) pump, a blower, a spa light and/or a heater module).

In accordance with a specific implementation, the bathing unit usage information is provided by a user of the bathing unit system through a user control interface. Optionally, the user control interface also enables the user to control the operational settings of the bathing unit system. Optionally still, the control interface is configured to convey information related to a condition associated with the sanitizing device.

In accordance with a specific example, the circulating system of the bathing unit system includes a circulation pump and the controller is configured for adjusting the amount of power supplied to the electrolytic cell at least in part based on usage of the circulation pump. In a non-limiting implementation, power is supplied to the electrolytic cell at least at a maintenance power level when the circulation pump is activated. The maintenance power level may be a variable power level and may be conditioned, for example, based on an amount of usage of the circulation pump.

In accordance with a specific example, the controller increases the amount of power to be supplied to the electrolytic cell to a boost power level when the bathing unit usage information conveys that that the bathing unit system is being used by one or more bathers. In a non-limiting example of implementation, the amount of power applied at the boost level and/or the duration of time the boost level is applied may be variable and may be conditioned, for example based on the maintenance power level and/or the number of bathers in the bathing unit system.

In a specific example of implementation, the power supplied to the electrolytic cell is a pulse width modulated (PWM) power signal and the controller controls the amount of power supplied to the electrolytic cell by varying a pulse width of the pulse width modulated power signal.

In accordance with another broad aspect, the invention relates to a controller for controlling a sanitizing device for sanitizing water in a bathing unit system including a receptacle for holding water in which an halide salt has been dissolved. The sanitizing device is configured for positioning in fluid communication with a circulation system of the bathing unit system for allowing water from the receptacle to flow through the sanitizing device. The sanitizing device causes the halide salt dissolved in the water flowing there through to be converted to an amount of free halogen, where the amount of free halogen generated is dependent on an amount of power supplied to the sanitizing device. The controller comprises an input for receiving data from a user control interface, wherein the user control interface is for enabling a user to enter information related to the bathing unit system. The controller also comprises a processing unit in communication with the input. The processing unit controls an amount of power supplied to the sanitizing device so as to control the amount of free halogen being generated. The processing unit adjusts the amount of power supplied to the electrolytic cell at least in part based on the information entered by the user at the user control interface.

In a specific example of implementation, the user control interface enables the user to enter information related to a number of bathers for the bathing unit system. The controller is responsive to information provided by the user and conveying the number of bathers for adjusting the amount of power supplied to the sanitizing device at least in part based on the number of bathers. Optionally, information related to a condition associated with the sanitizing device may also be conveyed through the user control interface.

In accordance with another broad aspect, the invention pertains to a controller in a bathing unit system having a receptacle for holding water in which an halide salt has been dissolved; a circulating system for removing and returning the water from and to the receptacle; a user control interface for enabling a user to enter commands for controlling operational settings associated with the bathing unit system and a sanitizing device for sanitizing water positioned in fluid communication with the circulation system for allowing water from the receptacle to flow through the sanitizing device. In use, electrical power is applied to the sanitizing device for causing the halide salt dissolved in the water flowing there through to be converted to an amount of free halogen. The controller is for controlling operational settings associated with the bathing unit system and comprises an input in communication with the user control interface and a processing unit in communication with the input. The processing unit controls operational settings associated with the bathing unit system based on commands entered at the user control interface. The processing unit also controls an amount of power supplied to the sanitizing device so as to control the amount of free halogen being generated, the amount of power supplied to the electrolytic cell being adjusted at least in part based on use of the bathing unit system.

In accordance with a specific example, the amount of power supplied to the electrolytic cell is adjusted at least in part based on an amount of use of the bathing unit system, the amount of use of the bathing unit system is derived at least in part based on the commands entered at the user control interface.

In accordance with a specific example, the processing unit receives data conveying a water temperature associated with the bathing system and for controlling operation of a heating device in the bathing unit system at least in part based on the water temperature. The processing unit also adjusts the amount of power supplied to the sanitizing device based at least in part on the water temperature.

In accordance with another broad aspect, the invention relates to a sanitizing system for use in sanitizing water in a bathing unit system, the bathing unit system including a receptacle for holding water in which an halide salt has been dissolved and a circulating system for removing and returning the water from and to the receptacle. The sanitizing system comprises a sanitizing device having a housing configured to be positioned in fluid communication with the circulation system for allowing water from the receptacle to flow through the housing. The sanitizing device also comprises an electrolytic cell positioned within the housing so that when power is applied to the electrolytic cell, the halide salt dissolved in the water flowing through the housing is converted to an amount of free halogen. The sanitizing system also comprises a controller configured for controlling an amount of power supplied to the electrolytic cell so as to control the amount of free halogen being generated. The controller receives data conveying water temperature information and adjusts the amount of power supplied to the electrolytic cell at least in part based on the water temperature information.

In a specific implementation, the controller processes the data conveying water temperature information to derive a water temperature correction factor and uses the derived water temperature correction factor to adjust the amount of power supplied to the electrolytic cell. The water temperature information may be obtained using a temperature probe positioned in any location suitable for measuring a water temperature associated with the bathing unit system. In non-limiting examples, the temperature probe may be positioned within the housing of the sanitizing device, within the circulation system of the bathing system or elsewhere in the bathing system.

In accordance with another broad aspect, the invention relates to a method for sanitizing water in a bathing unit system including a receptacle for holding water in which an halide salt has been dissolved and a circulating system for removing and returning the water from and to the receptacle. The method comprises providing an electrolytic cell in a housing configured to be positioned in fluid communication with the circulation system for allowing water from the receptacle to flow through the housing, so that when power is applied to the electrolytic cell, the halide salt dissolved in water flowing through the housing is converted to an amount of free halogen. The method also comprises controlling the amount of free halogen being generated by the electrolytic cell by adjusting an amount of power supplied at least in part based on use of the bathing unit system.

In accordance with another broad aspect, the invention provides a method for sanitizing water in a bathing unit system, the bathing unit system including a receptacle for holding water in which an halide salt has been dissolved and a circulating system for removing and returning the water from and to the receptacle. The method comprises providing an electrolytic cell in a housing configured to be positioned in fluid communication with the circulation system for allowing water from the receptacle to flow through the housing, so that when power is applied to the electrolytic cell, the halide salt dissolved in water flowing through the housing is converted to an amount of free halogen. The method comprises controlling the amount of free halogen being generated by the electrolytic cell by adjusting an amount of power supplied at least in part based a water temperature associated with the bathing unit system.

In accordance with another broad aspect, the invention provides a sanitizing system for use in sanitizing water in a bathing unit system, the bathing unit system including a receptacle for holding water in which an halide salt has been dissolved and a circulating system for removing and returning water from and to the receptacle, the circulation system including a circulation pump. The sanitizing system comprises a sanitizing device including a housing configured to be positioned in fluid communication with the circulation system for allowing water from the receptacle to flow through the housing. The sanitizing device also comprises an electrolytic cell positioned within the housing so that when power is applied to the electrolytic cell, the halide salt dissolved in the water flowing through the housing is converted to an amount of free halogen. The sanitizing system also comprises a controller configured for controlling an amount of power supplied to the electrolytic cell of the sanitizing device so as to control the amount of free halogen being generated, the controller adjusting the amount of power supplied to the electrolytic cell at least in part based on usage of the circulation pump.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 is a conceptual block diagram of a bathing unit system equipped with a sanitizing device in accordance with a first specific example of implementation of the present invention;

FIG. 2 is a block diagram of the sanitizing device shown in FIG. 1 in accordance with a specific non-limiting example of implementation of the present invention;

FIG. 3 is a block diagram depicting a controller for a sanitizing device in accordance with a specific example of implementation of the present invention;

FIGS. 4A and 4B are block diagrams depicting functional elements of a processor for use in the controller depicted in FIG. 3 in accordance with a specific example of implementation of the invention;

FIGS. 5A and 5B depict signal diagrams of exemplary PWM (pulse-width modulated) power signals for use in the sanitizing device depicted in FIG. 2 in accordance with a non-limiting example of implementation of the invention;

FIG. 6 is a flow diagram of a process implemented by the processor depicted in FIGS. 4A and 4B for adjusting an amount of power supplied to the sanitizing device at least in part based on usage of a circulation pump in accordance with a specific example of implementation of the invention;

FIGS. 7A and 7B are flow diagrams of a process implemented by the processor depicted in FIGS. 4A and 4B for adjusting an amount of power supplied to the sanitizing device at least in part based on usage of the bathing unit system in accordance with a specific example of implementation of the invention;

FIG. 8 is a flow diagram of a process implemented by the processor depicted in FIGS. 4A and 4B for adjusting an amount of power supplied to the sanitizing device at least in part based on water pressure information in accordance with a specific example of implementation of the invention;

FIG. 9 is a flow diagram of a process implemented by the processor depicted in FIGS. 4A and 4B for adjusting an amount of power supplied to the sanitizing device at least in part based on water temperature information in accordance with a specific example of implementation of the invention;

FIGS. 10A and 10B are flow diagrams of a process implemented by the processor depicted in FIGS. 4A and 4B for enabling diagnostic information and maintenance information related to the sanitizing device to be conveyed to a user of the bathing unit system in accordance with a specific example of implementation of the invention;

FIGS. 11A, 11B and 11C depict user control interface modules for use in connection with a sanitizing device in accordance with specific examples of implementation of the present invention;

FIG. 12 is a block diagram of an apparatus suitable for implementing the processor depicted in FIGS. 4A and 4B in accordance with a specific example of implementation of the present invention;

FIG. 13 is a block diagram of another bathing unit system equipped with a sanitizing device in accordance with an alternative example of implementation of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to a specific implementation of the invention in the context of a bathing unit system. It is to be understood that the term “bathing unit system”, as used for the purposes of the present description, refers to spas, whirlpools, hot tubs, bathtubs, therapeutic baths, swimming pools and any other type of bathing unit that can be equipped with a control system for controlling various operational settings.

It is also to be appreciated that the specific embodiment described herein is directed to a specific embodiment of the invention in which the halide salt used by the sanitization device is sodium bromide, which therefore results in the generation of bromine as the “halogen”. It is to be appreciated that alternative implementations of the invention may make use of other suitable types of halide salts. In non-limiting examples, the halide salt used is a salt wherein the negative counterion (i.e., anion) is chloride, bromide or iodide or any combination thereof. In other words the halide salt is sodium chloride, sodium bromide or sodium iodide or any combination thereof. In addition, as used herein, an “halogen” is chlorine, bromine or iodine or any combination thereof.

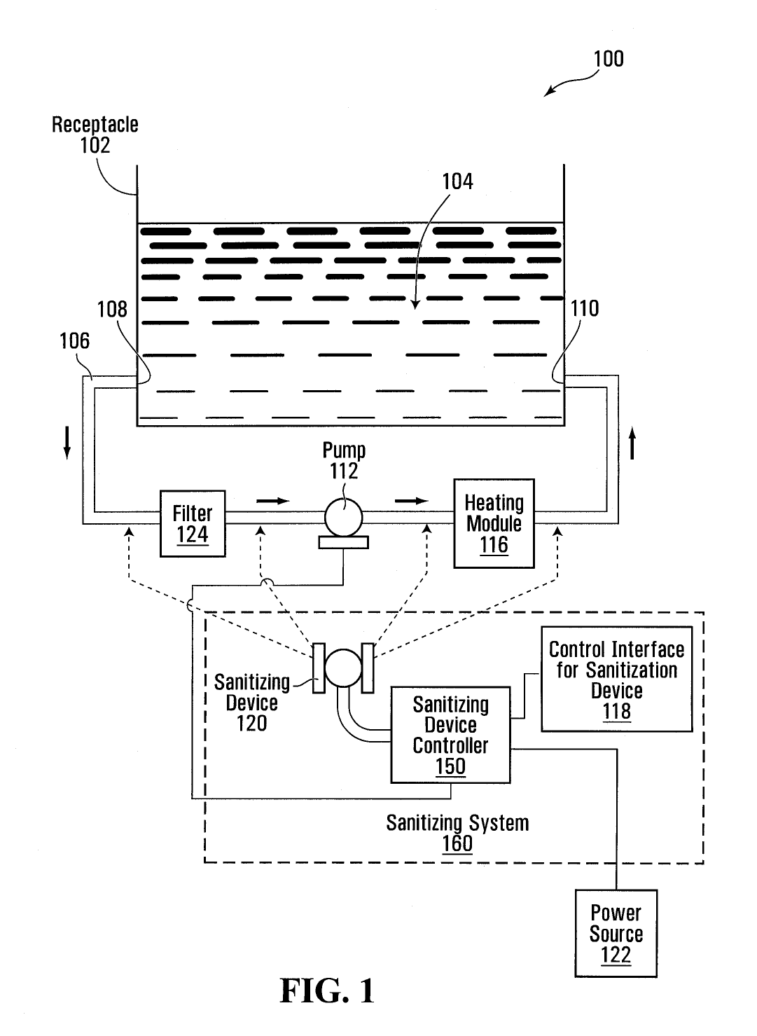

FIG. 1 illustrates a block diagram of a bathing unit system 100 incorporating a sanitizing system 160 in accordance with a specific example of implementation of the invention. The bathing unit system 100 includes a bathing unit receptacle 102 for holding water 104 in which an halide salt, such as sodium bromide, has been dissolved, water inlets 110 (only one is shown) which will typically be connecting to respective jets, water outlets 108 (only one is shown), and a circulation system 106 including a flow conduit for removing and returning water from and to the receptacle 102 through the water inlets and water outlets. The circulation system 106 depicted is shown as having a single flow conduit for the purpose of simplicity, however, the person skilled in the art will appreciate that practical implementations of bathing unit system may including multiple flow conduits interconnecting water inlets and water outlets to the receptacle 102. A heating module 116, a water pump 112 and a filter 124 are shown positioned within the circulation system 106. It should be understood that the bathing unit system 10 could include more or fewer bathing unit components which may be positioned in various suitable positions in the circulation system.

A bathing unit controller (not shown) controls the settings of the components in the bathing unit system 100 including the settings of the heating module 116, the water pump 112 and the filter 124. The controller (not shown) receives electrical power from an electric power source (not shown) and controls the distribution of power supplied to the various bathing unit components on the basis of control signals received from various sensors in order to cause a desired operational settings to be implemented. Manners in which the bathing unit controller may be configured and used to control the bathing unit components for the regulation of the operation of the bathing unit system 100 are known in the art and are not critical to the invention and as such will not be described in further detail here.

The bathing unit system 100 further includes a sanitizing system 160 for sanitizing the water 104 in the receptacle 102. As shown, the sanitizing system 160 comprises a sanitizing device 120, a (sanitizing device) controller 150 configured for controlling the operation of the sanitizing device 120 and a control interface 118 in communication with the controller 150. The controller 150 receives electrical power from an electric power source 122, which may be any suitable power source, and controls the distribution of power supplied to the sanitizing device 120. In a non-limiting example, the power source 122 is a 240 VAC power source. In the specific example depicted in FIG. 1, the controller also receives data related to the circulation pump 112. The data related to the circulation pump 112 may convey, for example, information related to the operational state of the circulation pump 112 (ON/OFF state) and information related to a water pressure within the pump. Optionally, the controller 150 may also be in communication with the controller (not shown) of the bathing unit.

The components of the sanitizing system 160 as well as their manner of operation will now be described with reference to specific examples of implementation thereof in the ensuing sections of the present specification.

### Sanitizing Device 120

As depicted in FIG. 1, the sanitizing device 120 is configured to be positioned in fluid communication with the circulation system 106 for allowing water from the receptacle 102 to flow through the sanitizing device 120 as it circulates through the circulation system 106 between the water outlet 108 and water inlet 110. As illustrated by the dotted lines in FIG. 1, the sanitizing device 120 may be positioned for example upstream or downstream from the pump 112, between the filter 124 and the heating module 116 or downstream from the heating module 116.

The sanitizing device 120 is configured as an halogen generator cells and cooperates with the 106 circulation system. As the water from the receptacle 102 is carried through the circulation system 106, the dissolved halide salt is carried through the sanitizing device 120. Electrodes in the sanitizing device 120 cause the salt to undergo electrolysis, which breaks the salt down into its basic elements, e.g., sodium and chlorine or sodium and bromine as the case may be. The circulation system 106 then returns the water to the water reservoir with an enhanced halogen level (e.g. chlorine or bromine) to provide sanitation and disinfecting action against bacteria, viruses, and algae. This cycle is repeated multiple times.

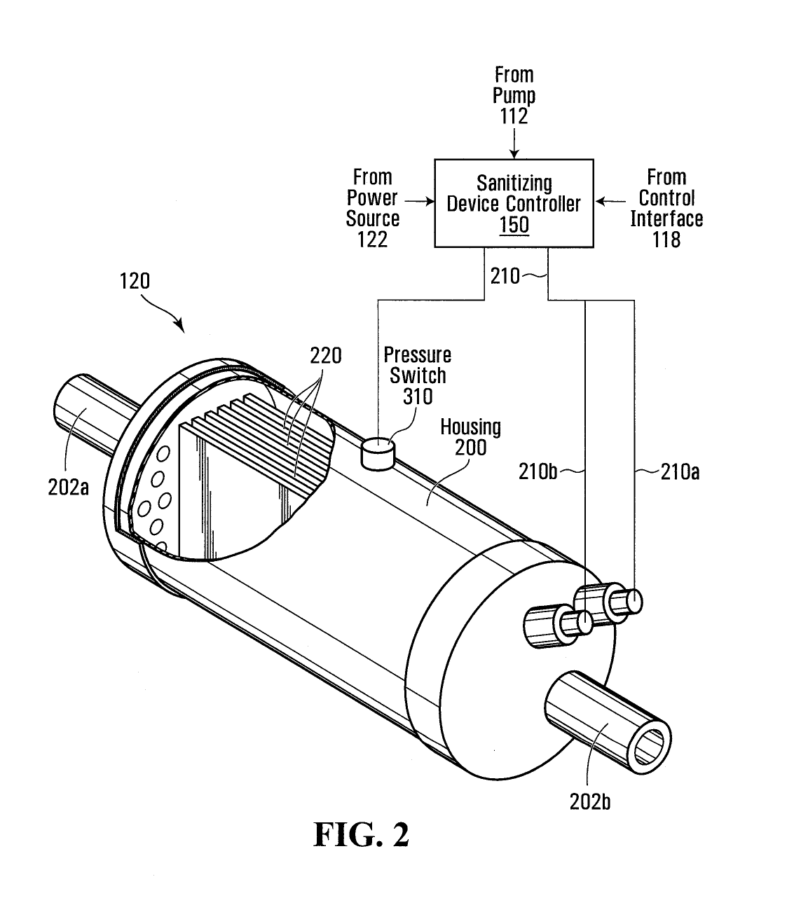

A specific example of implementation of the sanitizing device 120 will now be described with reference to FIG. 2 of the drawings.

As depicted, the sanitizing device 120 includes a housing 200 configured to be positioned in fluid communication with the circulation system 106 (shown in FIG. 1). The housing 200 includes a water inlet 202a and a water outlet 202b for allowing water from the receptacle to flow into and out of the housing 200. An electrolytic cell 220 is positioned within the housing 200.

In a specific non-limiting implementation, the electrolytic cell 220 includes a set of four (4) graphite plates positioned in a substantially parallel arrangement, with a gap of about 180 mils between each plate, each plate having a thickness of about 312 mils. The capability of the electrolytic cell 220 is a maximum DC current of 600 mA at 12 VDC. The applied voltage (12 VDC) enables current to flow from plates to plates, through the water in which was added the halide salt (for example Sodium Bromide (NaBr)), electrolysing the water to generate and release free halogen (e.g. free) bromine in the water. The halogen generation rate is proportional to the current output intensity. In a non-limiting example, the current output intensity is controlled by pulsing the 12 VDC output voltage applied to the electrolytic cell. It is to be appreciated that the above is but a non-limiting example of implementation of an electrolytic cell 220 that may be used in sanitizing device 120 and that many other suitable types of electrolytic cells may be used in alternative implementations of the invention.

The electrolytic cell 220 is connected to the controller 150 through connector lines 210a and 210b through which the electrolytic cell 220 receives power.

The application of a voltage to the plates of the electrolytic cell 220 while water containing a dissolved halide salt flows through the housing causes an electrolysis reaction to take place within the housing so that the halide salt dissolved in the water flowing through the housing is converted to an amount of free halogen. In the case where the water contains dissolved sodium bromide and power is applied to the electrolytic cell, a current is caused to travel through the water flowing in between electrode plates, which provides the energy necessary for the following electrochemical reaction:

H₂O+NaBr→Br₂+H₂+NaOH

(water)+(sodium bromide)→(bromine)+(hydrogen gas)+(sodium hydroxide)

The amount of free halogen generated by the sanitizing device 120 is dependent in part on the amount of power applied to the electrolytic cell 220. In order to modify the amount of free halogen generated, the current travelling between the plates of the electrolytic cell is adjusted to a desired level. In the embodiment depicted, the amount of power applied to the electrolytic cell 220 is controlled by the controller 150, which will be described below.

As depicted in FIG. 1, the sanitizing device 120 is placed in fluid communication with the circulation system 106 and with the pump 112 so that water is caused to flow through the housing of the sanitizing device 120. It is to be appreciated that an insufficient flow of water through the sanitizing device 120 while the power is being applied to the electrolytic cell will result in an increased accumulation of halogen within the sanitizing device 120. An insufficient flow of water through the sanitizing device 120 may be caused for example by an interruption of the operation of the pump 112 or by an obstruction in the circulation system 106. A significant increased accumulation of halogen within the sanitizing device 120 is undesirable. In the embodiment depicted in FIG. 2, the sanitizing device 120 is equipped with a pressure switch 310 in communication with the controller 150 for providing information regarding the water pressure in the housing 200. The information regarding the water pressure through the housing 200 can be used by the controller 150 in order to adjust (or interrupt) the power being supplied to the sanitizing device 120 in dependence on the water pressure through the housing. It is to be appreciated that alternative examples of implementation may make use of other suitable mechanisms for obtaining information related to water pressure, water flow and/or water level in the housing and for adjusting (or interrupting) the power being supplied to the sanitizing device 120 in dependence of such information. The configuration and functionality of the controller 150 will now be described in greater detail.

### The Controller 150

As indicated above, the controller 150 adjusts the amount of power supplied to the electrolytic cell 220 of the sanitizing device 120 in order to achieve a desired level of halogen generation for the bathing unit system 100 (shown in FIG. 1). In accordance with specific examples of implementation, the desired level of halogen generation for the bathing unit system 100 may be varied according to a number of factors including for example, but not limited to, whether the bathing unit system 100 is in use or not; the number of bathers in the bathing unit system 100; a rate of flow of the water through the sanitizing device; a water pressure inside the sanitizing device; a water temperature (for e.g. the temperature of the water 104 in the receptacle and/or the temperature of the water flowing through the sanitizing device 120) and an amount of halide salt in the water.

In a specific example of implementation, the controller 150 is configured cause the power to be supplied at a maintenance power mode during periods of low halogen requirements and a boost power mode during periods where an increased amount of halogen generation is required. The controller adapts the level and duration of the maintenance and boost modes of the halogen generator based on various factors, such as for example, but not limited to:
(i) the amount of down time of the pump 112;
(ii) number of bathers in the bathing unit system;
(iii) the power level during the maintenance mode;
(iv) the usage of the bathing unit;
(v) the temperature of the water;
(vi) the amount of halide salt in the water;
(vii) the volume of water in the bathing unit;
(viii) Maintenance performed on components of the bathing unit system (e.g. when the last time the filter was cleaned; the last time the water in the bathing unit was changed);

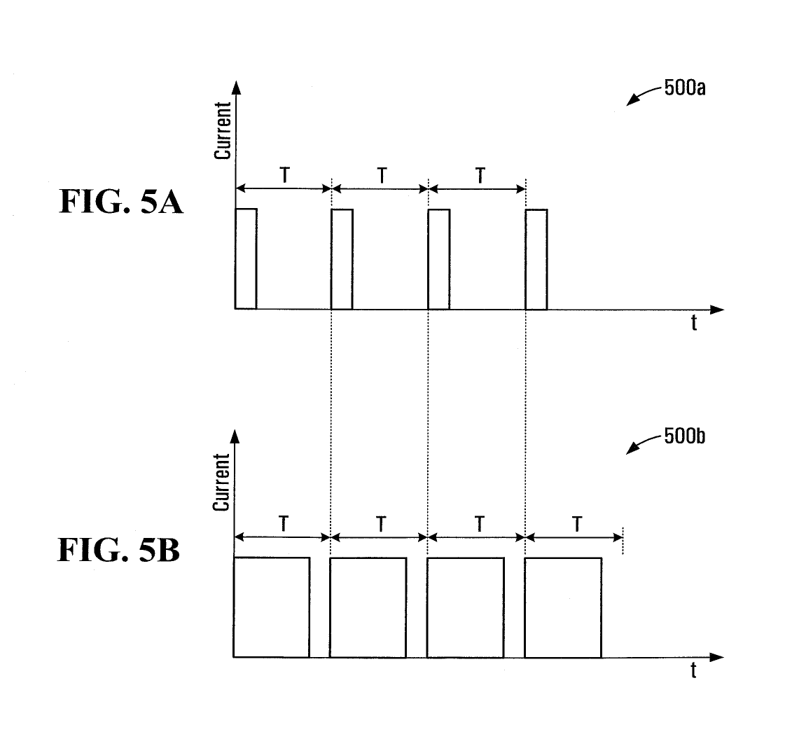

In a specific example of implementation, the controller 150 controls the level of the power supplied to the sanitizing device using a PWM-signal (Phase Width Modulated signal). In such an implementation, the power is switched ON and OFF, with the timing of the ON/OFF switching being set so that the power is ON for selected time duration in a period and OFF for the remainder of the period. FIGS. 5A and 5B depict signal diagrams of exemplary PWM (pulse-width modulated) power signals provided to the sanitizing device 120. In FIG. 5A, the power is turned on for about 20% of a period while in FIG. 5B the power is turned on for about 80% of a period. It is to be appreciated that using a PWM signal is but one specific manner in which the controller 150 may control the level of the power supplied to the sanitizing device and that other suitable manners of controlling the level of power may be used in alternative implementations of the invention. For example, the level of the power supplied to the sanitizing device may be controlled by applying different voltage levels to the plates of the electrolytic cell assembly 220 in order to induce different levels of current between the plates.

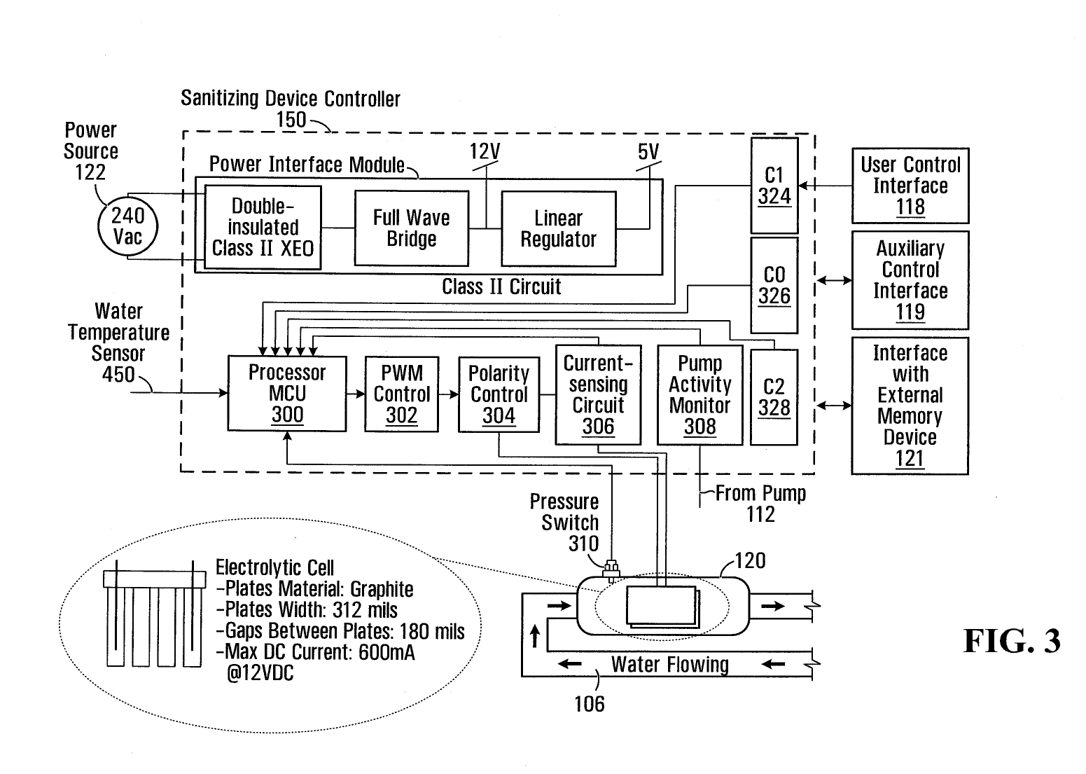

A block diagram of a specific implementation of the controller 150 will now be described with reference to FIG. 3 of the drawings.

As depicted, the controller 150 includes a power source interfacing module 321 for providing an interface between the controller 150 and the power source 122. The power source interfacing module 321 may include any suitable devices for converting an incoming power signal to a desired power level including high and low voltage components. In the non-limiting example depicted, the power source interfacing module 321 includes a double insulated Class II XEO, a full wave bridge and a linear regulator. Such devices are well-known in the art and are not critical to the present invention and as such will not be described in further detail here.

The controller 150 also includes one or more interfaces for exchanging signals with one of more external devices. In the example depicted, the controller 150 is shown as having three (3) interfaces, namely: interface C1 324 for exchanging signal with the sanitizing device user control interface 118; interface C0 326 for exchanging signal with an auxiliary control 119; and interface C2 328 for exchanging signals with an external memory device 121. Each one of interface C1 324, interface C0 326 and C2 328 may have any suitable physical configuration and may be either a wire-line or wireless interface. The wireless interface may be an IR (infra-red) interface, Bluetooth interface, RF interface for example. In a non-limiting example of implementation, the auxiliary control 119 is a portable remote control device configured to transmit commands to the controller 150 via and wireless link (e.g. an IR, RF or other). In another non-limiting example of implementation, the auxiliary control 119 is embodied as part of a bathing unit controller controlling the operational settings of the bathing unit system 100 depicted in FIG. 1. In yet another non-limiting example of implementation, the auxiliary control 119 is embodied as part of user control panel for allowing a user to enter commands for controlling operational settings of the bathing unit system 100 depicted in FIG. 1 in addition to the operational settings of the sanitizing device 120. In certain implementations, information related to a status of the sanitizing device 120 may be conveyed to a user through the user control interface 118 and/or the auxiliary control 119. It is to be appreciated that the interfaces C1 324, C0 326 and C2 328 is not critical to the present invention and may be implemented in any suitable manner known in the art and as such will not be described in further detail here.

Optionally, the controller 150 also includes a pump activity monitor 308 for receiving information related to pump 112 (shown in FIG. 1). In a specific example of implementation, the information received conveys the operational state of the pump 112. In the example depicted, the information related to pump 112 is collected using any suitable sensor device for monitoring the operational state of the pump 112. Alternatively, the pump activity monitor 308 is in communication with the bathing unit controller (not shown) which controls the operational settings of the different bathing unit components in the system 100 (shown in FIG. 1). In this alternative example, signals conveying the operational state of the pump 112 over time are sent from the bathing unit controller (not shown) to the sanitizing device controller 150 and received by the pump activity monitor 308. It will be appreciated by the person skilled in the art in light of the present description that alternative examples of implementation of the present invention may use other suitable mechanisms for monitoring the state of the pump 112.

Optionally, the controller 150 also includes a current sensing circuit 306 for receiving information related to a current being generated between the electrode plates in the sanitizing device 120. The information related to the current includes a measurement of the current being generated. In a specific example, a suitable current sensor is positioned within the sanitizing device 120 for obtaining current measurements related to the current between the electrode plates. The specific hardware used to obtain the current measurement is not critical to the invention an as such will not be described further here.

Optionally still, the controller 150 includes an interface 328 for exchanging signals with an external memory device 121, which may be a USB memory device, a PDA-type de (personal digital assistant), smart phone or other suitable communication device. The external memory device 121 may store programs and/or data which may be transmitted to the controller 150 through interface 328. Such programs and/or data may be used to update programs and data already stored in connection with processing unit 300 and/or may be used in order to configure the processor 300 and/or other components of the controller 150.

The controller 150 also includes processing components 300 302 304 for controlling the power supplied to the electrolytic cell of the sanitizing device 120.

More specifically, processing unit 300, which in FIG. 3 is shown as a microprocessor, is configured for determining the amount of power to be supplied to the electrolytic cell of the sanitizing device 120. The amount of power to be supplied is determined in part based on one or more parameters related to the bathing unit system 100 (shown in FIG. 1). The information may be obtained in a number of different manners such as for example, but not limited to:
1) by using one or more sensors positioned in the bathing unit system 100;
2) through the sanitizing device user control interface 118;
3) through an auxiliary control 119 such as (but not limited to):
   a. from a bathing unit control system;
   b. from a remote control device;
   c. from a user control panel associated with the bathing unit system 100;

In the example depicted in the figure, the processing unit receives inputs from interfaces C1 324, C0 326 and C2 328, from the pump activity monitor 308, from the current sensing unit 306 and from inputs providing other parameters related to the bathing unit system 100 and releases a signal conveying an amount of power to be supplied to the sanitizing device 120.

The PWM control device 302 receives the amount of power determined by the processing unit 300 and generates a corresponding pulse-width modulated power signal corresponding to the derived amount of power, such as for example signals of the type depicted in FIGS. 5A and 5B. For example, if the amount of power released by processing unit 300 indicates that the power is to be supplied at 20% of capacity, the PWM control device 302 generates a corresponding power signal.

The polarity control device 304 receives the power signal generated by the PWM control device 302 and is adapted for periodically switching (reversing) the polarity of the potential applied to the electrode plates in the sanitizing device 120. In a specific implementation, the polarity of the potential applied to the electrode plates is switched every 5 minutes however it will be appreciated by the person skilled in the art that other switching rates may be used in alternative implementations. The switching (reversing) of the polarity allows preventing an accumulation of build up of deposits on the electrode plates. The resulting power signal is released and applied to the electrode plates of the electrolytic cell, for example, by applying a voltage through connectors 210a and 210b shown in FIG. 2, such as to cause halogen generation within the sanitizing device 120.

Examples of the manner in which the amount of power may be determined by the processing unit 300 will now be described.

### Processing Unit 300

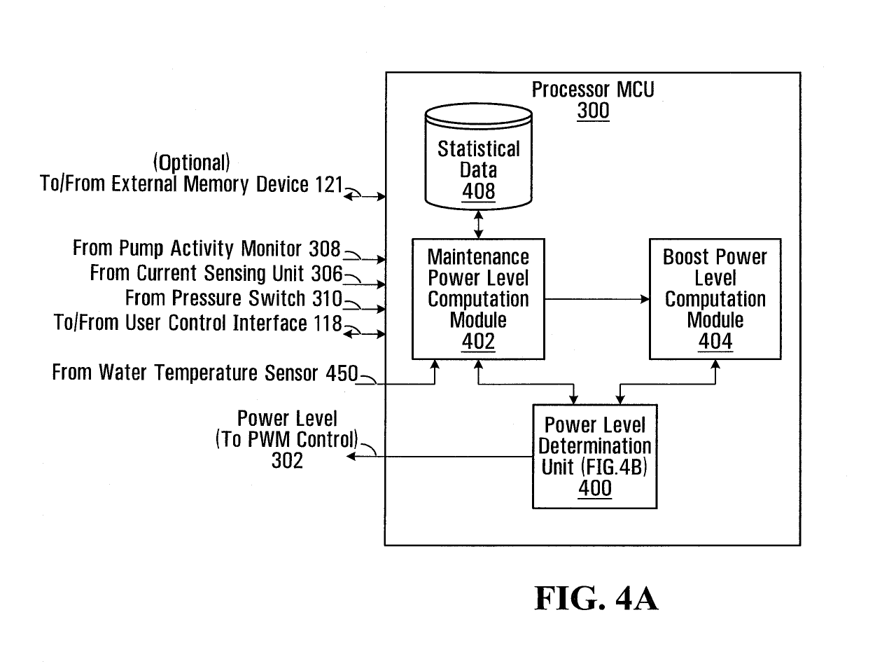

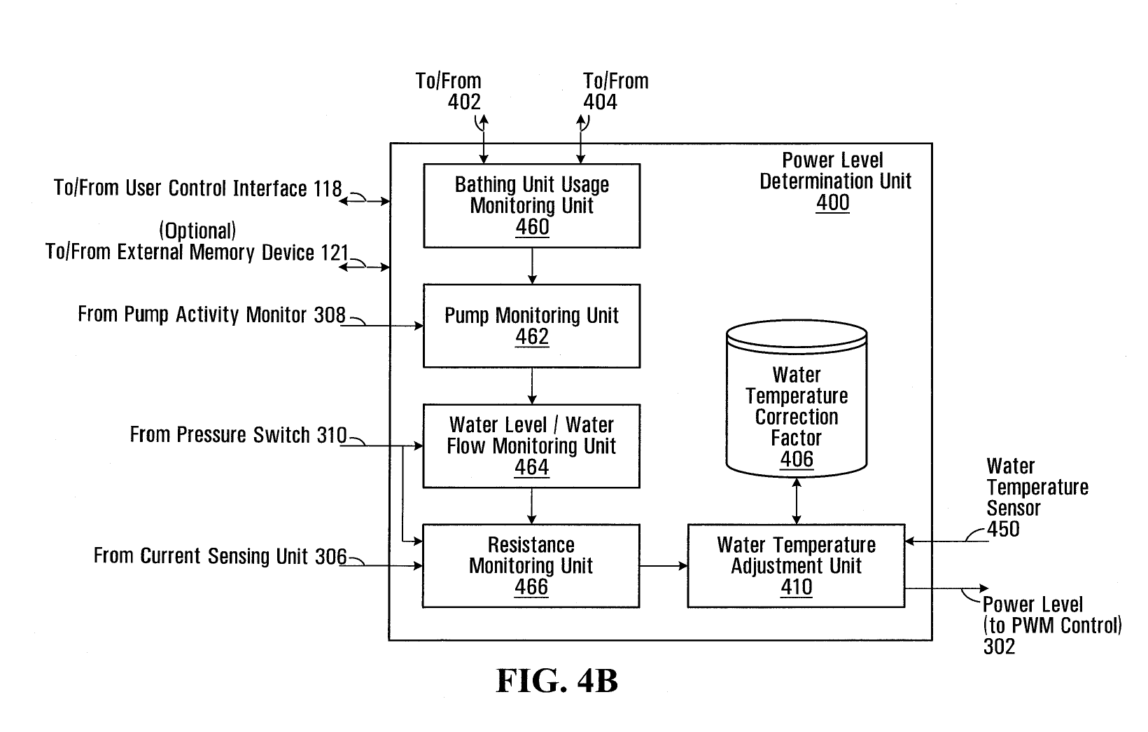

FIGS. 4A and 4B depict a functional block diagram of processing unit 300 in accordance with an embodiment of the invention. As depicted, processing unit 300 receives signals conveying various information related to the sanitizing device 120 and the bathing unit system 100 including information from the pump activity monitor 308, from the current sensing unit 306, from the pressure switch 310, from control interfaces 118 and 119, from an external memory device 121 and from a water temperature sensor 450. This information is processed to derive a power level to be applied to the sanitizing device 120. This power level is released to the PWM control device 302 (shown in FIG. 3) which in turn generates the appropriate PWM signals.

As shown in FIGS. 4A and 4B, the processing unit 300 includes a number of functional modules implementing various processes for determining a power level to be applied to the sanitizing device 120. As depicted in FIG. 4A, the processing unit 300 includes a maintenance power level computation module 402, a boost power level computation module 404 and a power level determination unit 400.

It is to be appreciated that the embodiment depicted is presented for the purpose of illustrations that practical implementations of the processing unit 300 may include additional functional modules and/or may omit certain functional modules depicted in FIG. 4A.

### The Maintenance Power Level Computation Module 402

The maintenance power level computation module 402 implements a process for determining the power level to be applied during the maintenance mode. As was indicated above, the processing unit 300 is configured to provide the sanitizing device 120 with power at a maintenance power level and at a boost power level. During such time the sanitizing device 120 is being provided at a maintenance power level, the sanitizing device 120 is said to be operating in the “Maintenance Mode”. A purpose of the “Maintenance Mode” is to keep the bromine levels at a stable and acceptable range when the bathing unit system is not being used.

It is generally desirable to maintain bromine at a constant level, and within the recommended range, when the spa is not being used or left unused for an extended period of time. For instance, the recommended bromine level is generally between 2 and 5 PPM.

In a specific example of implementation, the maintenance power level computation module 402 derives a maintenance level, which varies between 1 and 100, corresponding to a percentage of the maximum halogen generation level of sanitizing device 120. For example, a maintenance level of 40 corresponds to a power level equivalent to 40% of the maximum halogen generation level of the sanitizing device 120; a maintenance level of 80 corresponds to a halogen generation level equivalent to 80% of the maximum level of the sanitizing device 120; a maintenance level of 100 corresponds to a halogen generation level equivalent to the maximum level of the sanitizing device 120 and so on. The selected maintenance level depends on a number of factors including, but not limited to, the size of the receptacle 102 of the bathing unit system 100 (shown in FIG. 1), the capacity of the sanitizing device 120 and the desired halogen (bromine) level. In the specific practical example described here, the maximum current that can travel between the electrode plates of the sanitizing device is 600 mA. It is to be appreciated that the maximum current depends in part in the physical configuration of the electrolytic cell used in the sanitizing device and hence may vary in alternative examples of implementation of the invention. In the case of maintenance level of 50, the sanitizing device would hence generate a current of 300 mA for a 24 hour time period.

In accordance with a specific example, the maintenance power level computation module 402 derives a first (initial) maintenance level based on information provided by the user of the bathing system 100 through user control interface 118. The information provided by the user may include an explicit indication of the (initial) maintenance level to be applied and/or may provide parameters based on which the (initial) maintenance level is to be computed. The parameters may include a water volume associated with the receptacle of the bathing unit system 100 (or a bathing unit model number), capacity information related to the sanitizing device 120 (or a model number) and any other type of information for determining an (initial) maintenance level. In a non-limiting example, the (initial) maintenance level computation module 402 implements a process allowing to map a bathing unit water volume to a corresponding (initial) maintenance level using either a formula and or a mapping table stored in memory. Such mapping can be derived using a heuristic approach in order to obtain an (initial) maintenance level to achieve a certain desired halogen level. The specific manner in which the maintenance power level computation module 402 may derive an (initial) maintenance level based on parameters is not critical to the present invention and as such will not be described in further detail here.

Alternatively, the controller 150 may be programmed with a default (initial) maintenance level.

Optionally, the maintenance power level computation module 402 is configured to adjust the (initial) maintenance power level depending on the operating statistics of the sanitizing device 120.

More specifically, when the sanitizing device 120 is initially activated, the maintenance power level computation module 402 assumes that there will be continuous water flow through the device 120 and hence sets the effective maintenance level to correspond to the initial maintenance level provided based on information obtained through the user control interface 118 or provided as a default. If we look at the amount of bromine that gets generated in a 24-hour time window, and assuming that the sanitizing device is in constant operation, it is noted that the maximum halogen generation corresponds to a current of 600 mA being continually supplied over a 24-hour period. Therefore, a maintenance level of 25, corresponding to 25% of the maximum halogen generation, corresponds to a current of 150 mA being continually supplied over a 24-hour period.

It is to be observed that if the maintenance level was initially set to 25, corresponding to 150 mA for a 24 hour time period, but the pump was only left ON for 12 hours and hence the sanitizing unit 120 also only operated for 12 hours, the actual halogen (bromine) generation would be less then expected with a maintenance level set to 25.

In accordance with a specific implementation, the maintenance power level computation module 402 monitors the periods of activation of the sanitizing device 120 and adjusts the effective maintenance level to correspond to a modified version of the initial maintenance level. For example, if the maintenance power level computation module 402 determines that the periods of activation of the sanitizing device 120 corresponds to a total of 12 hours for a 24-hour time period, an initial maintenance level of 25, corresponding to 25% of the maximum halogen generation, would correspond to a current of 300 mA being supplied for 12 hours (This corresponds to 25% of 600 mA*24 h/12 h). Therefore the adjusted maintenance level would be 50 (25*24/12=50), corresponding to 50% of the maximum power for the 12 hour time period. In another example, if the maintenance power level computation module 402 determines that the periods of activation of the sanitizing device 120 corresponds to 8 hours for a 24-hour time period, a maintenance level of 25, corresponding to 25% of the maximum halogen generation, would correspond to a current of 450 mA being supplied for 8 hours (This corresponds to 25% of 600 mA*24 h/8 h). Therefore the adjusted maintenance level would be 75 (25*24/8=75), corresponding to 75% of the maximum power for an 8 hour time period.

In a specific example, the maintenance power level computation module 402 updates on a periodic basis the adjusted maintenance level based on statistics related to the activation of the sanitizing device 120. The frequency of updates may vary from one implementation to the other. In a non-limiting practical implementation, the maintenance power level computation module 402 is programmed for updating the adjusted maintenance power level about every 30 minutes based on operational statistics of the sanitizing device 120. Operational statistics related to the sanitizing device 120 may be stored in a memory 408 in communication with the maintenance power level computation module 402. The memory unit 408 may be implemented using any suitable memory device such as an EPROM, EEPROM, RAM, FLASH or any other suitable type of memory device. The operational statistics may convey various information related operational status of the sanitizing device 120 including information obtained from the pump activity monitor 308 (or from information from the pressure switch 310) and information related to an amount of time the sanitizing device 120 has been active and at what power level. It is to be appreciated that the operational statistics may be stored for limited amounts of time used in the computation of the maintenance power level by module 402, for example a 24 hour period, after which they are overwritten by new operational statistics. Alternatively, operational statistics may be stored for longer time periods (e.g. a few weeks) so that they may be used for diagnostic purposes, for example. Optionally, operational statistics may be provided through an external memory device 121 and/or information stored in memory device 408 may be uploaded to an external memory device 121 where they may be used for a number of tasks include for example diagnostic tests.

In a specific example of implementation, the maintenance power level computation module 402 is configured to monitor the amount of halogen generated by the sanitizing device 120 indirectly by monitoring the time water has been flowing through the device 120. It can monitor this by obtaining information relating to the spa pump usage obtained through the pump activity monitor 308. More specifically, the sanitizing device 120 to generated halogen for the bathing unit system 100 requires that water flows through the housing and hence requires that the pump 112 be activated to cause a flow of water while it is operating. When the pump 112 is deactivated, either because the user turned off the pump, because of an energy savings mode or for some other reason, the rate of water flow decreases to a level that does not permit the sanitizing device 120 to function in a desirable manner and hence the sanitizing device 120 is turned off while the pump is deactivated. Hence by maintaining statistic as to the usage of the pump 112, statistics related to activation of the sanitizing device 120 are also obtained.

The maintenance level computation module 402 releases information conveying a power level to be applied to the sanitizing device during the maintenance mode. This power level is provided to the power level determination unit 400 and in certain implementations to the boost level computation module 404, both of which are described below.

### The Boost Computation Module 404

It has been observed that halogen (e.g. bromine concentration) in spa water is partly dependent on usage of the spa. For example, a larger number of users or more frequent usage of the spa will require a higher generation of bromine due to water loss through splashing, higher microorganism content and so on. In the specific example of implementation, the processing unit 300 is configured for increasing the amount of power to be supplied to the electrolytic cell, thereby increasing the amount of halogen being generated, when the bathing unit usage information conveys that that the bathing unit system is being used by one or more bathers.

As was indicated above, the processing unit 300 is configured to provide the sanitizing device 120 with power at a maintenance power level and at a boost power level. During such time the sanitizing device 120 is being provided at a boost power level, the sanitizing device 120 is said to be operating in the “Boost Mode”. The boost power level computation module 404 implements a process for determining the power level to be applied during the boost mode and/or the duration of time during which the boost mode should remain in effect before reverting back to the maintenance mode.

Advantageously, providing a boost mode and a maintenance mode allows optimizing the generation of halogen based on the amount of halogen required. More specifically, when higher levels of halogen are required, such as while the bathing unit is being used and soon thereafter, higher levels of halogen are required and power is supplied at a boost mode. It will be appreciated that using a boost mode allows using a lower power level (and hence a lower amount of halogen generation) during the maintenance mode when the system is not being used and less halogen is required. This in turn results in enhanced energy efficiency.

In a specific example of implementation of the invention, based in part on the usage information related to the bathing unit system, the boost power level computation module 404 computes an amount of additional power required, which corresponds to an additional amount of halogen. The boost power level computation module 404 then processes this amount of additional power required in order to derive a time duration during which the boost mode is to be applied.

In a specific implementation, the usage information used by the boost power level computation module 404 conveys an amount of use of the bathing unit system 100 and may be provided in a number of different manners. For example, the usage information may be conveyed from user control interfaces 118 and 119 (shown in FIG. 3).

In a first example of implementation, when the usage information conveys that the bathing unit system is in use, the boost power level computation module 404 is programmed for determining a fixed additional amount of power to be provided to the sanitizing device 120. For example, the boost power level computation module 404 may determine that an additional 600 mA is to be provided to the sanitizing device 120 each time use of the bathing unit system is initiated.

In a second example of implementation, the boost power level computation module 404 is programmed for adjusting the amount of additional power to be provided to the sanitizing device 120 based on an amount of usage of the bathing unit system. In a specific example the amount of usage may be conveyed by a number of bathers using the bathing unit system. For example, the boost power level computation module 404 may determine that an additional 300 mA is to be provided to the sanitizing device 120 for each user of the bathing unit system. If the user indicates that there will be three (3) bathers for the system 100, the boost power level computation module 404 will determine that the amount of additional power required is 900 mA (three (3) bathers×300 mA). In a specific implementation, the boost power level computation module 404 makes use of a set of data elements providing a mapping between the number of bathers and respective the additional amounts of power to be provided. Such mappings may be stored in a memory (not shown) in communication with boost power level computation module 404. The contents of the table may be derived based on experimental data for example. Preferably, the total power (in mA) is adjusted such that the halogen levels are kept constantly within a specific range, e.g. 3-5 ppm for bromine.

The boost power level computation module 404 can use the number of bathers as one factor amongst others in a calculation for determining the amount of additional power to be provided to the sanitizing device 120 for the boost power level. Examples of other factors that may be used in determining an amount of additional power to be provided may include, without being limited to:
the temperature of the water in the bathing unit system 100 (in the example depicted this may also be taken into account by the optional water temperature adjustment module 410 shown in FIG. 4B);
the duration of the current users' usage of the system 100; and/or
the time elapsed since certain maintenance were performed to the sanitizing system 160.

It will be understood that the above list of factors that may be included to determine the amount of additional power to be provided to the sanitizing device 120 for the boost mode is non-exhaustive as other suitable factors may also be used in alternative examples of implementation.

In a specific example, during the boost mode the power supplied to the sanitizing device 120 is increased from the maintenance level to the maximum power level of the sanitizing device 120. It is to be appreciated that the power supplied during the boost mode may be increased to an amount below the maximum power level. In addition, the level of power supplied during the boost mode may vary dependent on different factors, including for example the number of bathers and the water temperature. For example, the boost power level may be related to the number of bathers for the bathing unit system 100, such that the greater the number of bathers, the higher the boost power level is set. For the purpose of simplicity, the example describe below will illustrate an embodiment where power is increased to the maximum power level during the boost mode. The manner in which the power level may be adapted during the boost mode based on various factors will become apparent to the person skilled in the art in light of the present description and as such will not be described further here.

Once the boost power level computation module 404 has determined the amount of additional power to be applied for the boost mode, the boost power level computation module 404 processes the amount of additional power required in order to derive a duration for which the boost mode is to be applied before reverting back to the maintenance level. In particular, the process by which the boost power level computation module 404 determines the duration during which the power to the sanitizing device 120 is adjusted to the boost power level may be based at least in part on the maintenance power level for the device 120.

In a specific example of implementation, the excess capacity of the sanitizing device (maximum current—current used during the maintenance mode) is used to generate an addition halogen amount to attack the additional pollutants during the boost mode. Since the boost mode relies on the excess capacity of the sanitizing device, the higher the maintenance level, the lower the amount of power available to generate additional amounts of halogen and hence the longer the required duration of the boost mode.

In order to illustrate the above consider the following example: assume that the boost mode computation module 404 determines that an additional amount of halogen corresponding to a total of 900 mA is required based on the usage information provided. Also assume that the total amount of current that can be applied by the sanitizing device 120 (maximum capacity) is 600 mA and that in the maintenance mode the device 120 is set to use 150 mA. As such, there would be 450 mA excess capacity available for use by the boost mode. In such cases, the boost mode computation module 404 would determine that the duration of time the boost mode would be applied at maximum capacity would be 2 hours (900 mA/450 mA) after which, the device 120 returns to the maintenance mode. Alternatively, if in the maintenance mode the device 120 is set to use 300 mA, there would be 300 mA excess capacity available for use by the boost mode. In such cases, the boost mode computation module 404 would determine that the duration of time the boost mode would be applied at maximum capacity would be 3 hours (900 mA/300 mA) after which, the device 120 returns to the maintenance mode. As illustrated above, the duration of time during which the boost mode is to be applied is based in part on the maintenance level which it receives from the maintenance level computation module 402. In cases where the maintenance level computation module 402 derives an adjusted maintenance level, the boost power level computation module 404 makes use of the adjusted maintenance level in order to derive the duration during which the boost mode is to be applied.

As a result, the boost power level computation module 404 provides a boost power level and a duration during which the boost power level is to be applied.

### The Power Level Determination Module 400

The power level determination module 400 determines the level at which power should be supplied to the sanitizing device 120. In a specific implementation, the power level determination module 400 determines whether the level at which power should be supplied should be:
disabled;
supplied at a maintenance level as computed by the maintenance power level computation module 402;
supplied at a boost level for a duration time as computed by the boost power level computation module 404.

The power level determination module 400 may include a number of functional sub-modules for monitoring various conditions related to the sanitizing device 120 and the bathing unit system 100 in order to determine a power level to be supplied to the sanitizing device 120. FIG. 4B shows a functional block diagram of the power level determination module 400 in accordance with a specific example of implementation.

As shown, the power level determination module 400 includes a bathing unit usage monitoring unit 460, a pump monitoring unit 462, a water level/water flow monitoring unit 464, a water resistance monitoring unit 466 and a water temperature adjustment module 410. It is to be appreciated that in alternative implementations the power level determination module 400 may include fewer or additional functional modules. The functional modules 460, 462, 464, 466, and 410 receive signals originating from various sources including the user control interface 118, the pump activity monitor 308, the pressure switch 310, the current sensing unit 306, the external memory device 121 and the temperature sensor 450, and release a power level to the PWM control 302 (shown in FIG. 3).

In the specific example depicted in the figures, the bathing unit usage monitoring unit 460 selects between a maintenance power level and a boost power level based on usage information related to the bathing unit system 100. Modules 462 464 and 466 act as switches preventing power from being supplied to the sanitizing device 120 when certain conditions related to the pump 112, the level/flow of water in the sanitizing device 120 or the resistance of the water do not satisfy certain criteria. The optional water temperature adjustment module 410 adjusts the power level based on a water temperature measurement.

The functionality provided by each of the functional modules 460, 462, 464, 466 and 410 is illustrated below.

### Bathing Unit Usage Monitoring Unit 460

It has been observed that halogen (e.g. bromine concentration) in spa water is partly dependent on usage of the spa. For example, a larger number of users and/or more frequent use of the spa will require a higher generation of bromine due to water loss through splashing, higher microorganism content and so on.

In accordance with a specific implementation, the power level determination unit 400 adjusts the amount of power supplied to the sanitizing device 120 based on usage information related to the bathing unit system 100.

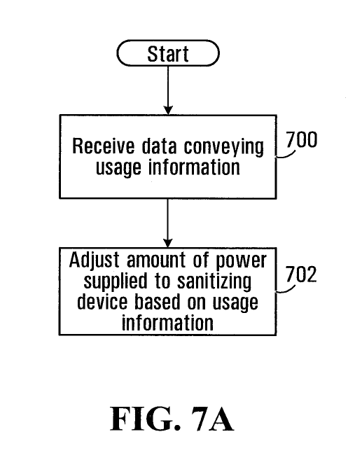

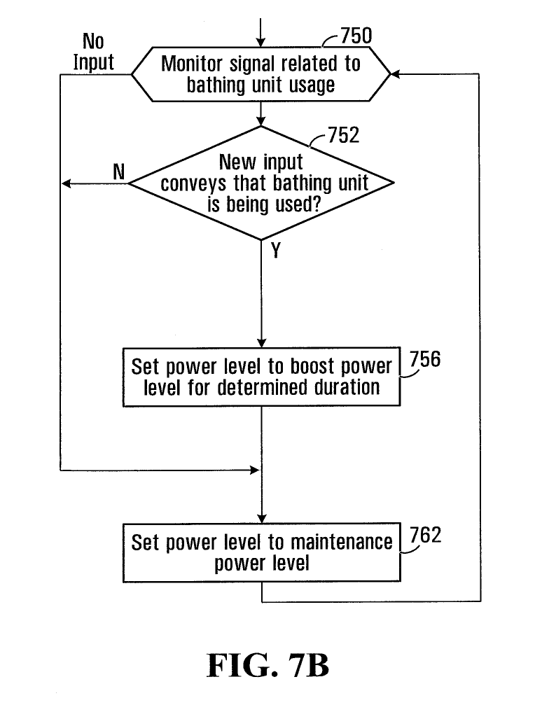

This functionality is implementation by the bathing unit usage monitoring unit 460 which will now be described with reference to FIGS. 7A and 7B. FIGS. 7A and 7B are flow diagrams illustrating a power-adjustment process that describes how the bathing unit usage monitoring unit 460 may determine and implement such power adjustments. It will be appreciated that FIG. 7A illustrates a general process by which the bathing unit usage monitoring unit 460 may make power adjustments, while FIG. 7B illustrates a specific example of such a process.

With reference to FIGS. 7A and 7B, at step 700, the bathing unit usage monitoring unit 460 receives data conveying usage information. Bathing unit usage information may be conveyed in a number of different ways. For example, bathing unit usage information may be obtained by monitoring the current drawn by bathing unit components (e.g., current drawn by a heater module, a jet pump, a blower, lights). For instance, signals indicating that the water pumps and/or the spa lights have been turned “ON” may be used to infer that the bathing unit is being used. In another example, explicit information related to usage of the bathing unit system may be provided. In particular, such information may be provided from the control interface 118 or from auxiliary control interface 119 (shown in FIG. 3).

While further details regarding the control interface 118 and its usage are provided below, it is sufficient in the context of this process to understand that this interface can prompt a user to enter information related to usage of the bathing unit, including for example the number of bathers for the bathing unit system 100. It is also to be appreciated that the bathing unit usage information may convey that the bathing unit is not being used. Such information may be conveyed implicitly, by an absence of receipt of information conveying use of the bathing unit system 100, or explicitly, through the transmission of signals conveying the status of one or more components in the system 100.

At step 702, the bathing unit usage monitoring unit 460 adjusts the amount of power supplied to the sanitizing device 120 based on the usage information obtained at step 700. More specifically, the bathing unit usage monitoring unit 460 selects between the maintenance level computed by the maintenance level computation module 402 and the boost level computed by the boost level computation modules based on the usage information received at step 700. For instance, when the usage information conveys that the bathing unit system is not being used, the bathing unit usage monitoring unit 460 selects the power level determined by the maintenance level computation module 402 described above. Conversely, when the usage information conveys that the bathing unit system is being used, the bathing unit usage monitoring unit 460 selects the power level and applies it for a duration of time determined by the boost level computation module 404 before reverting to the maintenance level determined by the maintenance level computation module 402.

A specific example of a power-adjustment process that is performed by the bathing unit usage monitoring unit 460 will now be described with reference to FIG. 7B.

As shown, at step 750, bathing unit usage monitoring unit 460 monitors incoming signals conveying usage information related to the bathing unit system. In a specific example, this would include monitoring signals originating from the control interface 118.

At step 752, the bathing unit usage monitoring unit 460 determines whether the bathing unit system is being used in view of selecting either the boost mode or the maintenance mode. More specifically, if at step 752 it is determined based on explicit or implicit information that the bathing unit system is not being used, the process proceed to step 762.

At step 762, the bathing unit usage monitoring unit 460 selects the maintenance mode where the power level is selected to correspond to (or remain at) the maintenance power level, which was determined by the maintenance level computation module 402 shown in FIG. 4A.

On the other hand, if at step 752 it is determined that the bathing unit system is being used, the process proceed to step 756. At step 756 the bathing unit usage monitoring unit 460 selects the boost mode where the power level is selected to correspond to the boost power level. In the specific embodiment described, the boost power level and the amount of time during which the boost mode is to remain in effect is determined by the boost level computation module 404 shown in FIG. 4A. Once the time duration of the boost mode has expired, the process proceeds to step 762, where the power level is selected to correspond to the maintenance power level.

Following step 762, the process returns to step 750 where the signals related to usage of the bathing unit system continue to be monitored.

Optionally, the bathing unit usage monitoring unit 460 may cause information related to whether power is being supplied to the sanitizing device in maintenance or boost mode to be conveyed through the control interface 118 shown in FIG. 1.

### Pump Monitoring Unit 462

The pump monitoring unit 462 (shown in FIG. 4B) monitors the operational status of the pump 112 (show in FIG. 1). Recall that pump 112 causes water to flow through the sanitizing device 120. If pump 112 is not in operation, the pump monitoring unit 462 acts as a switch for preventing power from being supplied to the sanitizing device 120.

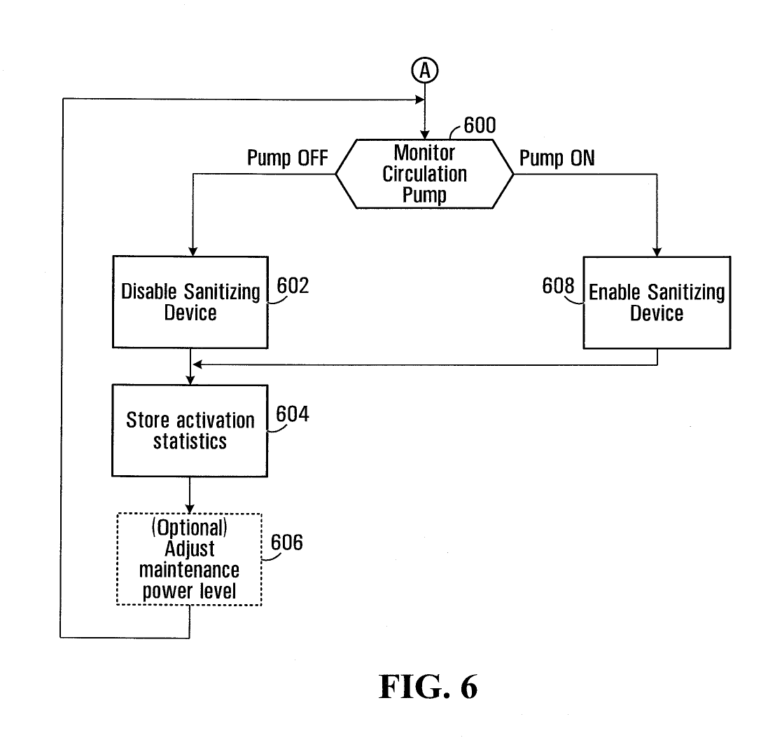

The functionality of the pump monitoring unit 462 will now be described with reference to FIG. 6, which shows a flow diagram for a circulation pump-monitoring test process.

At step 600, the pump monitoring unit 462 receives information related to the operational state of the circulation pump 112 from the pump activity monitor 308. In a non-limiting example, the pump 112 will be in one of two states, namely:
a Pump ON state (where the pump 112 is enabled and causes water to flow through the circulation system including sanitizing device 120); or
a Pump OFF state (where the pump 112 is disabled).

Based on the state reported by the pump activity monitor 308, the pump monitoring unit 462 makes a decision as to the step(s) in the process to perform next. More specifically, the pump monitoring unit 462 will proceed to perform steps 602, 604 and (optionally) 606 if the pump activity monitor 308 reported that the pump 112 is in the Pump OFF state. Otherwise, if the monitor 308 reported that the pump 112 is in the Pump ON state, the pump monitoring unit 462 performs steps 608, 604 and (optionally) 606.

At step 602, the pump monitoring unit 462 disables the sanitizing device 120 (for example the switch is opened to set to prevent power from being supplied). As such, while the pump 112 is disabled, no power is supplied to the sanitizing device 120 and no halogen is generated.

At step 604, activation statistics related to the circulation pump 112 are stored in memory unit 408 (shown in FIG. 4A).

At step 606, the maintenance level for the sanitizing device 120 may be optionally be caused to be adjusted by the maintenance level computation module 402 to take into account the activation statistics stored at step 604.

As mentioned previously, step 608 occurs if pump monitoring unit 462 determines that the circulation pump 112 is currently enabled (i.e., the Pump ON state is found at step 600). At this step, the pump monitoring unit 462 enables power to be supplied to the sanitizing device 120.

It will be appreciated that the conclusion of step 606 (or step 604, should optional step 606 not occur) results in a new iteration of the circulation pump-monitoring process being performed as the process returns to step 600. Such repeated iterations allow changes to the current state of the circulation pump 112 to be identified and cause the sanitizing device 120 to be subsequently disabled or enabled in response.

The circulation pump-monitoring process described above with reference to FIG. 6 may be performed at regular intervals (e.g., 1-minute intervals) in order to identify any changes in the current state of the circulation pump 112. In an alternative embodiment, the circulation pump-monitoring process may be initiated in response to a detected change in the current state of the pump 112. For example, if pump monitoring unit 462 receiving a signal from monitor 308 indicating that that the pump 112 has switched from a Pump ON state to a Pump OFF state the process may be initiated so that the sanitizing device 120 may be disabled.

Optionally, the pump monitoring unit 462 may cause such information related to the operational status of the pump 112 to be conveyed through the control interface 118 shown in FIG. 1.

### Water Level/Water Flow Monitoring Unit 464

As indicated above with reference to FIG. 4B, the power level determination unit 400 includes a water level/water flow monitoring unit 464. The water level/water flow monitoring unit 464 monitors the level of water, the flow of water and/or the water pressure in the sanitizing device 120. Recall that the sanitizing device 120 when activated assumes that there is a continuous flow of water circulating there through. If there is an insufficient level of water and/or an insufficient flow of water through the sanitizing device 120, the water level/water flow monitoring unit 464 acts as a switch for preventing power from being supplied to the sanitizing device 120.

In the embodiment described in this example, a pressure switch 310 is used to measure the water pressure inside the sanitizing device 120. The water pressure measurement is used as an indicator of water flow. It is to be appreciated that alternative implementations may make use of flow detectors instead of (or in addition to) the pressure switch 310.

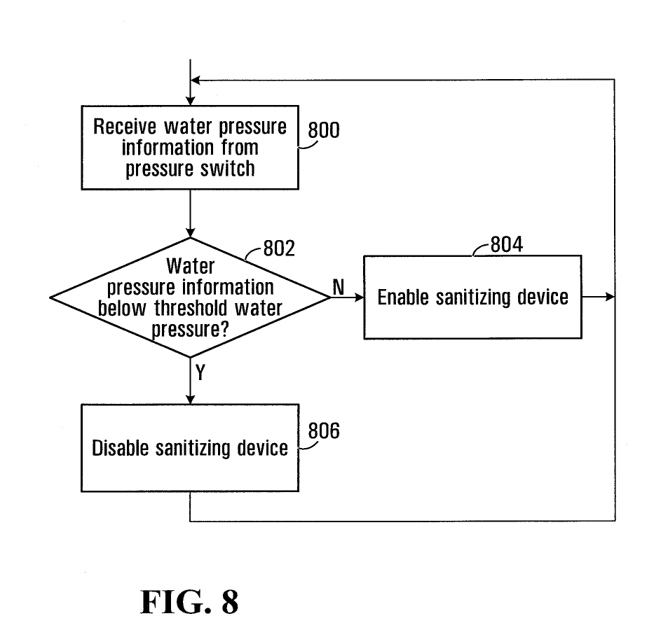

The functionality of the water level/water flow monitoring unit 464 will now be described with reference to FIG. 8.

At step 800, the water level/water flow monitoring unit 464 receives a signal from pressure switch 310 conveying information as to the water pressure in the housing of the sanitizing device 120.

At step 810, the water pressure information is processed to determine whether it conveys a potentially insufficient water flow through the sanitizing device 120. An insufficient water flow may for example convey a potential blockage either upstream or downstream from the sanitizing device 120. The sufficiency of water flow may be assessed, for example, by comparing the water pressure information conveyed by the pressure switch 310 against a threshold water pressure. If the water pressure information conveyed by the pressure switch 310 is below the threshold pressure, the process proceeds to step 806. Other wise, the process proceeds to step 804 where the water level/water flow monitoring unit 464 enables power to be supplied to the sanitizing device 120.

At step 806, the sanitizing device 120 is disabled (for example the switch is opened to set to prevent power from being supplied). As such, while there is insufficient water flow through the sanitizing device, no power is supplied to the sanitizing device 120 and no halogen is generated. Optionally, activation/deactivation statistics related to the sanitizing device 120 are stored in memory unit 408 (shown in FIG. 4A) so that they may be taken into account by the maintenance level computation module 402.

It will be appreciated that the conclusion of either of steps 804 or 806 may result in a new iteration of the process being performed as the process returns to step 800. Such repeated iterations allow changes to the water pressure in the sanitizing device to be identified and cause the sanitizing device 120 to be subsequently disabled or enabled in response.

The process described above with reference to FIG. 8 may be performed at regular intervals (e.g., 1-minute intervals).

Optionally, the water level/water flow monitoring unit 464 may cause such information related to the results of the process applied and described with reference to FIG. 8 to be conveyed through the control interface 118 shown in FIG. 1.

### Water Temperature Adjustment Module 410

It has been observed that variations in water temperature cause variations in electrolysis halogen yields from halide salt. For instance, at a given power level and at low water temperature the electrolysis halogen yields (concentration, i.e. ppm (parts per million)) from a halide salt is different than at the power level but at a higher water temperature.

As depicted in FIG. 4B, the power level determination unit 400 includes an optional water temperature adjustment module 410 for compensating for the above variation of electrolysis halogen yields from halide salt. In a specific example, water temperature adjustment module 410 modifies the power level to be applied to the sanitizing device 120, as determined by the bathing unit usage monitoring unit 460, based on a water temperature measurement. In one embodiment, the water temperature adjustment module 410 maps a water temperature measurement, received from water temperature sensor 450, to a corresponding corrective factor and adjusts the power level based on the corrective factor in order to compensate for variations in water temperature. Mathematically, this may be expressed as follows:

temperature adjusted power level=F(water temperature)*power level

where F(water temperature) is a function for deriving the corrective factor.

The mapping between the water temperature and the corrective factor may be provided in a table stored in a memory unit, such as memory unit 406, which provides a mapping between a water temperatures and corrective factors. Such mappings may be derived using experimental measurements of the halogen yields from halide salt for a given halide salt concentration at different water temperatures. Alternatively, the mapping may be provided by means of a formula allowing deriving a corrective factor based on a temperature measurement. The relationship between temperature and the amount of halogen generated for a constant power applied to the sanitizing device for a constant concentration of halide salt can be derived by taking measurements of the halogen in the water at a certain number of water temperatures and then using mathematical techniques, such as for example linear regression, in order to derived the relationship between temperature and the amount of halogen generated. It is also to be observed that the relationship between temperature and the amount of halogen can also take into account different power levels and/or different concentrations of halide salt which may also be derived in the above described manner.

The memory unit 406 may be implemented using any suitable memory device such as an EPROM, EEPROM, RAM, FLASH or any other suitable type of memory device.

The person skilled in the art will appreciate that the water temperature sensor 450 from which the water temperature measurement originates may be suitably located in the bathing unit water piping upstream/downstream or within the housing of sanitizing device 120. It should, however, be understood that the temperature sensor can also be positioned in other suitable locations, such as in the receptacle 102 of the bathing unit system 100.

The water temperature adjustment module 410 releases information conveying a temperature adjusted power level to be applied to the sanitizing device 120.

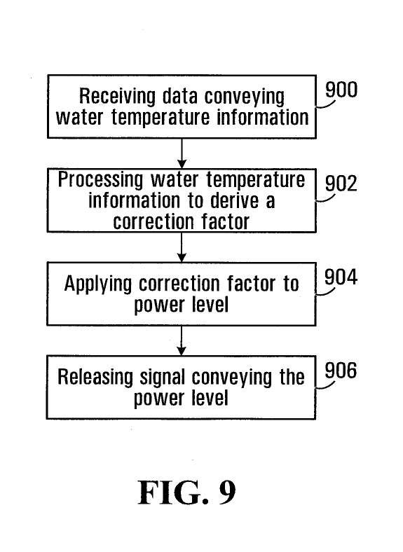

FIG. 9 depicts a process implemented by the water temperature adjustment module 410 to adjust a power level to be applied to the sanitizing device 120 based on a water temperature associated with the bathing unit system 100.

As depicted, at step 900, the water temperature adjustment module 410 receives data conveying a water temperature measurement from a water temperature sensor 450. At step 902, the water temperature measurement is processed to derive a corresponding power correction factor. In a specific example of the implementation, the power correction factor is derived based on information stored in memory 406 mapping water temperature to respective correction factors. Alternatively, the corrective factor may be derived based on a (mathematical) correlation formula stored on memory 406. At step 904, the water temperature adjustment module 410 applies the power correction factor to the power level derived by the bathing unit usage monitoring unit 460 to derive a temperature adjusted power level. Finally at step 906 the temperature adjusted power level is released.

It is to be appreciated that the power level determination unit 400 depicted in FIG. 4B may be configured for adjusting the amount of the power supplied to the sanitizing device 120 based on factors other than water temperature, such as for example the flow rate of water through the sanitizing device 120 and/or the concentration of the halide salt in the water. In implementations where water flow rates are used to adjust the power level, data stored in a memory unit (not shown) and/or a mathematical algorithm providing a mapping between water flow rates and corresponding corrective factors for adjusting the amount of power being supplied may be used. Similarly, for implementations in which the concentration of halide salt in the water is used to adjust the power level, a memory unit and/or a mathematical algorithm providing a mapping between halide salt concentrations and corresponding corrective factors for adjusting the amount of power being supplied may be used. The manner in which such functionality may be implemented will become apparent to the person skilled in the art in light of the present description and as such will not be described in further detail here.

### Resistance Monitoring Unit 466

The resistance monitoring unit 466, shown in FIG. 4B, monitors the condition of the water within the sanitizing device 120 in order detect a number of abnormal situations. In particular, resistance monitoring unit 466 monitors the resistance of the water within the sanitizing unit 120 to determine whether the concentration of halide salt in the water is suitable and/or to determine whether there is an excess halogen generation within the sanitizing unit 120. It is to be appreciated that the resistance of the water flowing through the sanitizing device 120 is affected by the chemicals in the water including amongst others the concentration of halide salt in the water. Generally speaking, the concentration of halide salt in the water between the electrode plates of the sanitizing unit 120 can be inferred from the resistance value of the water. If the sanitizing unit 120 is configured to operate within a range of halide salt concentration, this range of concentration will hence correspond to a range of resistance values. When resistance values are below or above this range, this results in non-ideal operating conditions and may even cause damage to the sanitizing device 120. The resistance monitoring unit 466 acts as a switch for preventing power from being supplied to the sanitizing device 120 in situations where the concentration of halide salt in the water is not suitable. The resistance monitoring unit 466 may also generate information for guiding a user of the bathing unit system in the maintenance of the system, for example by identifying whether a certain amount of halide salt and/or water should be added to the bathing unit system to achieve proper operation of the sanitizing system 160 (shown in FIG. 1).

It is also to be noted that a blockage in the circulation system 106 upstream from the sanitizing device 120 may result in excess halogen gas in the sanitizing device 120. Such a blockage may sometimes not be conveyed through information gathered from the pressure switch 310 and as such may not have been detected by the water level/water flow monitoring unit 464 described above. In particular, in cases where the halide salt is sodium bromine, the chemical reaction that takes place in the sanitizing device 120 may be expressed as follows:

H₂O+NaBr→Br₂+H₂+NaOH

(water)+(sodium bromide)→(bromine)+(hydrogen gas)+(sodium hydroxide)

As will be observed, in the presence of insufficient water flow, a build up of hydrogen gas and halogen may occur inside the sanitizing device 120 (as per the above formula) which in turn may damage the electrodes in the electrolytic cell of the sanitizing device 120. In such cases, the hydrogen gas augments resistance between the electrodes of the sanitizing device, which resistance can then be measured and used in the detection of an insufficient water flow.

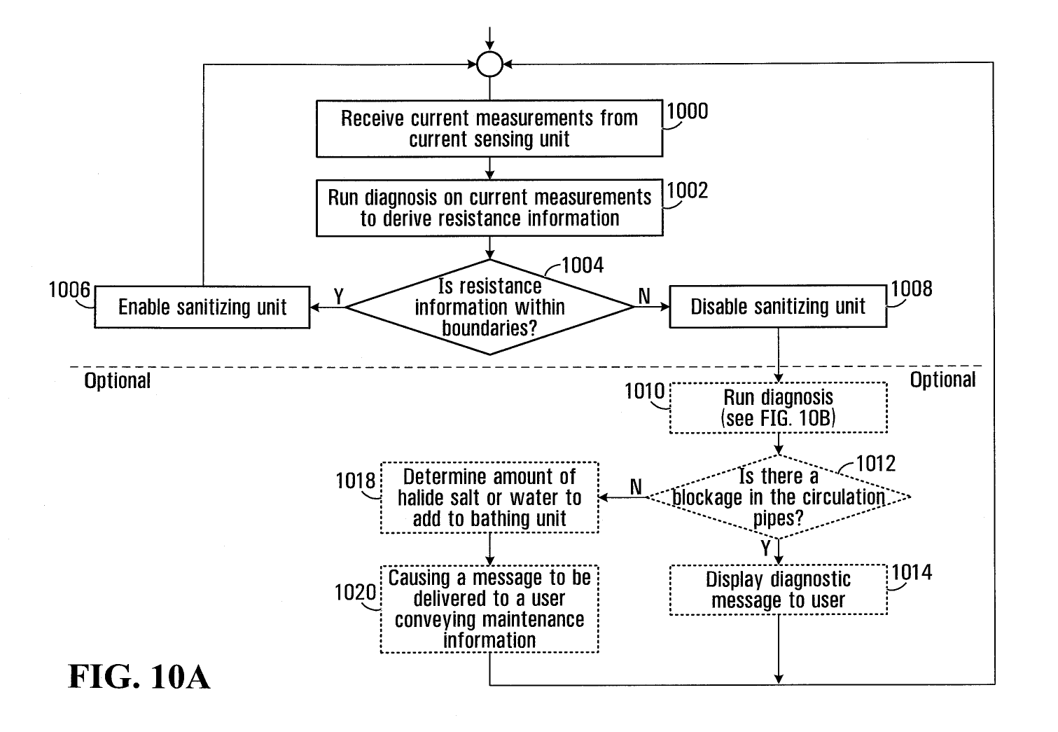

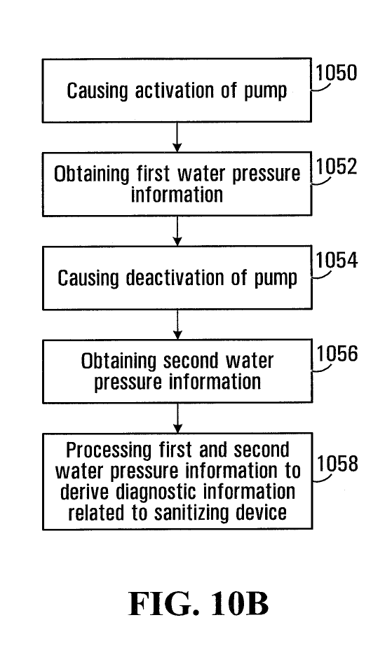

The functionality of the resistance monitoring unit 466 will now be described with reference to FIGS. 10A and 10B.

At step 1000, the resistance monitoring unit 466 receives current measurements from the current sensing circuit 306 which convey amounts of current circulating between the electrode plates of the sanitizing device 120. In a non-limiting example of implementation, the current measurements obtained at step 1000 are obtained following the temporary application of a known diagnostic power level to the electrolytic cell. In a non-limiting example, the diagnostic power level used during step 1000 is set to 25% of the maximum power. It is however to be appreciated that any suitable power level may be used when obtaining the current measurement at step 1000.

At step 1002, the resistance monitoring unit 466 processes the received measurements from step 1000 in order to derive resistance information. More specifically, since the voltage applied by the controller 150 to the electrode plates of the sanitizing device 120 is known, the resistance of the water through which the current flows through can be derived using known relationships between voltage/current and water resistance using the current measurement obtained at step 1000.

At step 1004, the resistance information is processed to determine whether it falls between boundaries of acceptable resistance values. A resistance value that is lower than a low boundary value may for example convey an excessive amount of halide salt in the water. Conversely a resistance value that is higher than a high boundary value may for example convey an insufficient amount of halide salt in the water or an insufficient water flow through the sanitizing device. A high resistance value may also convey the presence of an air trap within the sanitizing device. As a non-limiting example, assume that the boundaries define a range of resistances between 17Ω to 38Ω. If the resistance information derived at step 1002 falls within the range defined by the boundary (e.g., 20Ω), then the process proceeds to step 1006 and the resistance monitoring unit 466 enables power to be supplied to the sanitizing device 120. Optionally, at step 1006, the resistance monitoring unit 466 may derive information related to concentration of halide salt in the water based in part on the resistance information obtained at step 1002 and cause such information (in the form of a message with textual or visual elements) to be conveyed through the control interface 118 (shown in FIG. 1).

If the resistance information derived at step 1000 falls outside of the boundaries, then the process proceeds to step 1008 and the resistance monitoring unit 466 prevents power to be supplied to the sanitizing device 120.

Optionally, following steps 1006 and 1008, activation/deactivation statistics related to the sanitizing device 120 are stored in memory unit 408 (shown in FIG. 4A) so that they may be taken into account by the maintenance level computation module 402.

The process may also includes a set of optional steps, labeled 1010, 1012, 1014, 1018 and 1020, which may be performed in order to attempt to identify a reason why the resistance measurement derived at step 1002 lies outside the determining resistance value boundaries.

At step 1010, the resistance monitoring unit 466 runs a diagnosis to identify a potential reason why the measured resistance did not fall within the boundary. In a specific implementation, the diagnostic procedure performed at step 1010 seeks to differentiate between a resistance measurement falling outside the boundaries due to an excessive (or insufficient) amount of halide salt in the water and a resistance measurement due to an excessive amount of halogen in the sanitizing device caused by a blockage in the circulation system 106.

An exemplary diagnostic procedure implemented at step 1010 is shown in greater detail in FIG. 10B.

At step 1050, the resistance monitoring unit 466 issues a signal for causing the pump 112 (shown in FIG. 112), which connected with fluid communication with the sanitizing device 120, to be activated. This may be effected by sending a signal from the controller 150 to the controller (not shown in the figures) of the bathing unit system instructing the latter to activate the pump 112. Alternatively, the pump 112 and controller of the sanitizing device 120 may be configured such that the controller 150 directly controls the operations of pump 112. In such alternative implementation the resistance monitoring unit 466 issues a signal directly to the pump 112 for causing the pump to be activated.

At step 1052, while the pump 112 is activated, the resistance monitoring unit 466 obtains first water pressure information conveying a water pressure in the sanitizing device 120.

In the specific implementation, the first water pressure is obtained from pressure switch 310.

Following this, at step 1054, the resistance monitoring unit 466 issues a signal for causing the pump 112 (shown in FIG. 112) to be deactivated. In a manner similar to that described for step 1050, this step may be effected by sending a signal from the controller 150 to the controller of the bathing unit system (not shown in the figures) instructing the latter to deactivate the pump 112. Alternatively, the pump 112 and controller 150 may be configured such that the controller 150 directly controls the operations of pump 112. In such alternative implementation the resistance monitoring unit 466 issues a signal directly to the pump 112 for causing the pump to be deactivated.

At step 1056, following the deactivation of the pump 112, the resistance monitoring unit 466 obtains second water pressure information conveying a water pressure in the sanitizing device 120. In the specific implementation, the second water pressure is obtained from pressure switch 310.

At step 1058, the first water pressure information obtained at step 1052 and the second water pressure information obtained at step 1056 are processed to derived diagnostic information related to the sanitizing device 120. More specifically, the first water pressure information is compared to the second water pressure information to determine whether they differ by a sufficient amount. If the difference between the water pressures is below a certain threshold (indicating that the activation of the pump 112 resulted in little change in the water pressure inside the sanitizing device 120), step 1058 infers that there is a blockage in the circulation path in which the sanitizing device 120 is located. If the difference between the water pressures is above certain threshold, step 1058 infers that there is no blockage in the circulation path in which the sanitizing device 120 is located.

Returning now to FIG. 10A, at step 1012, a determination is made as to whether a blockage in the circulation path was detected. If a blockage is detected, the process proceeds to step 1014.

At step 1014, the resistance monitoring unit 466 causes a diagnostic message to be displayed to the user of the bathing unit system. More specifically, the resistance monitoring unit 466 issued a signal that would cause information (such as a message with textual or visual elements) to be conveyed through the control interface 118 (shown in FIG. 1). The message could be conveyed on a display screen as visual element such as text (e.g., “PIPE MAY BE BLOCKED!”) and/or graphic elements, such as an icon of a pipe with a blockage. Alternatively the message may be conveyed using other visual elements, such through the use of LEDs for example. The message may also provide certain additional troubleshooting or maintenance information, such as to instruct the user to check the inlet or outlet ports for the pipes and/or provide the contact number for the manufacturer or service representative. The process then returns to step 1000.

Returning now to step 1012, if the diagnosis performed in connection with step 1010 does not convey a blockage in the circulation path, step 1012 infers that a reason the resistance measurement derived at step 1002 lies outside the determining resistance value boundaries is due to an improper amount of halide salt in the water and proceeds to step 1018.

At step 1018, the resistance monitoring unit 466 determines an estimated amount of halide salt (or estimated amount of water) to be added to the bathing unit system 10 in order for the resistance of the water in the sanitizing device to reach a target value, the target value being within the desired boundaries. The computation of the amount of halide salt to add (or water to add) is based in part on the current resistance of the water (as derived in step 1002), a target resistance value and the total volume of water in the receptacle 102 of the bathing unit system 10.

Mathematically, this may be expressed as follows:
(1) if actual resistance of water>target resistance of water then:

Estimated amount of salt to add=F(actual resistance of water−target resistance of water, volume of water in bathing unit)
(2) if actual resistance of water<target resistance of water then:

Estimated amount of water to add=G(target resistance of water−actual resistance of water, volume of water in bathing unit)

F(x,y) and G(x,y) are any suitable functions that allow deriving an amount of salt (or amount of water) to add to a volume of water to achieve a target resistance of water, corresponding to a desired concentration of halide salt. The specific functions F(x,y) and G(x,y) used may vary from one implementation to the other. In a non-limiting example, F(x,y) and G(x,y) are implemented using a set of tables mapping differences between the actual resistance of water and the target resistance of water to a corresponding amount of water or salt to add. Such mappings are provided for each volume of water in a set of reference volumes of water.

The parameter pertaining to the volume of water in the bathing unit may be programmed in the resistance monitoring unit 466 as corresponding to the volume of the receptacle 102 in bathing unit system 100 (shown in FIG. 1). The parameter may also be provided by the user of the bathing unit system 100 through user control interface 118 during the set of the sanitizing system 160.

Once an estimate of the amount of halide salt (or water) to be added to the bathing unit system has been determined at step 1018, the system proceeds to step 1020.

At step 1020, the resistance monitoring unit 466 causes a maintenance message to be displayed to the user of the bathing unit system. More specifically, the resistance monitoring unit 466 issues a signal that causes information (such as a message with textual or visual elements) to be conveyed through the control interface 118 (shown in FIG. 1). The message may convey information indicating that there is an excessive (or insufficient) amount of halide salt in the water. The message may also provide additional maintenance information, such as the amount of water and/or halide salt to be added that was determined during prior step 1018. The message could be conveyed on a display screen as visual element such as text (e.g., “ADD SALT” or “ADD 150 g of SALT”), “ADD WATER” or “ADD 15 liters of WATER”) and/or graphic elements such as an animated icon of a water bucket being poured (in the case where more water must be added) or a salt-shaker (in the case where more halide salt must be added). Alternatively the message may be conveyed using other visual elements, such through the use of LEDs for example.

The process then returns to step 1000.

In a specific example of implementation, the process described with reference to FIGS. 10A and 10B is performed periodically in order to monitor the resistance of the water flowing through the sanitizing device. In a non-limiting example the process is performed every hour. Optionally, the process described with reference to FIGS. 10A and 10B is performed in response to a user request entered on user control interface 118 or provided through auxiliary interface 119.

### Control Interface 118

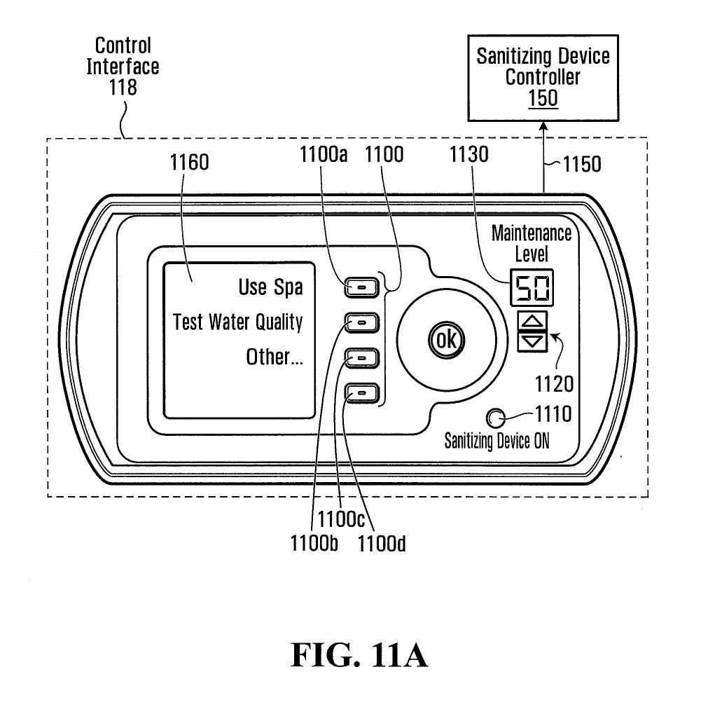

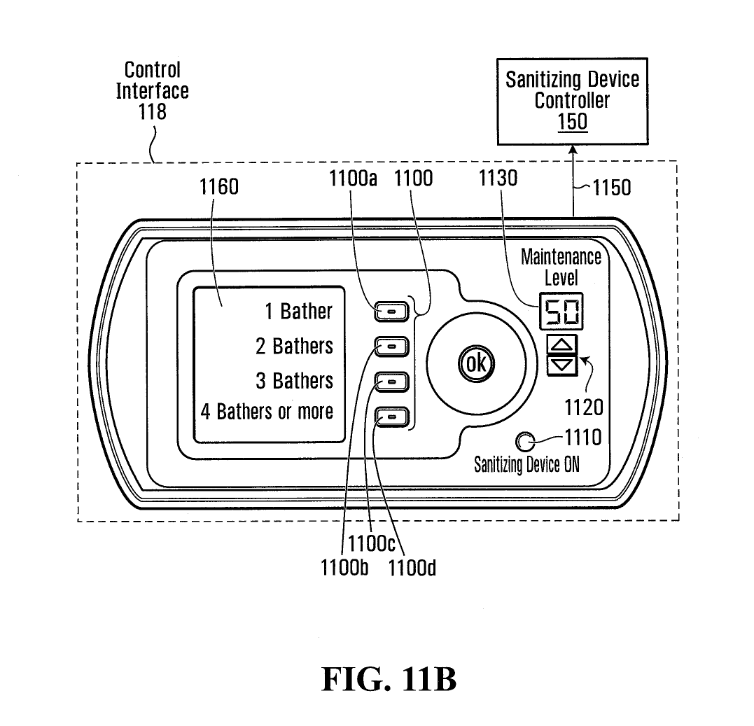

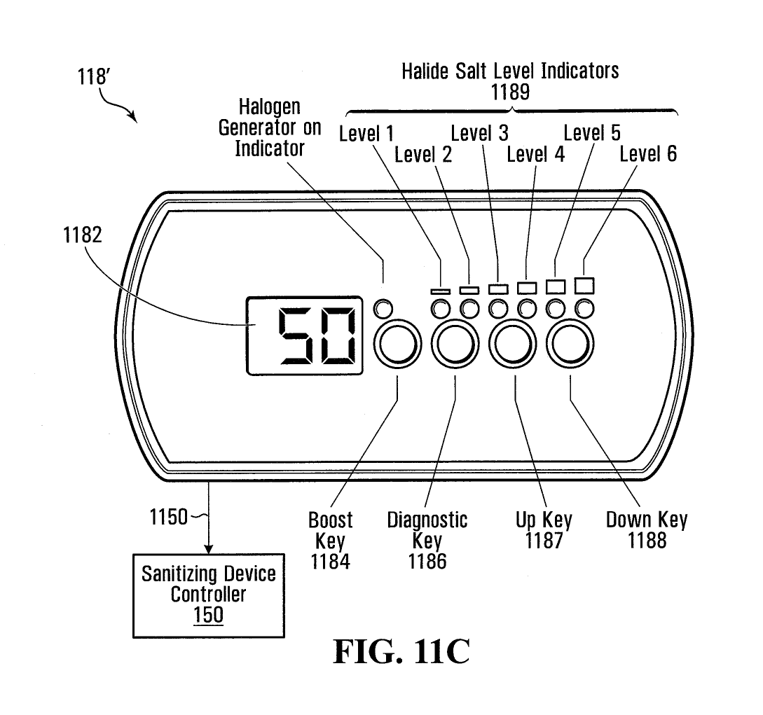

With reference to FIGS. 11A and 11B, there is shown a non-limiting embodiment of the user control interface 118 that is suitable for use with the bathing unit system 100 shown in FIG. 1. In a specific embodiment, the control interface 118 is connected to, and thus in communication with, the sanitizing device controller 150.

The control interface 118, in accordance with the practical implementation depicted in FIG. 11A, may comprise a set of user-operable controls 1100 and 1120 for enabling a user to enter information, a communications link 1150 for exchanging signals with the controller 150 of the sanitizing device, visual display elements (which in FIG. 11A includes a display screen 1160, an LED 1110 and a numerical display 1130) and a processor (not shown) for implementing the functionality of the control interface 118. The communications link 1150 may be a wire line link or a wireless link. The control interface 118 is typically installed in such as way as to be accessible to a user of the bathing unit system 100 and may be located on or adjacent to the receptacle of the bathing unit system or may be located remotely there from. It will be appreciated that the control interface 118 may alternatively comprise addition visual indicators, such as Light-Emitting-Diodes (LED), that can be selectively activated and deactivated to convey desired information to the user.

The user control interface 118 allows a user of the bathing unit system 100 to provide certain information for use by the controller 150 in controlling the operation of the sanitizing device 120. In addition, the control interface 118 also receives from the controller 150 certain information relating to the sanitizing device 120 (such as the operational status of the sanitizing device 120) so that such information may be conveyed to the user(s) of the system 100.

In the non-limiting example depicted in FIG. 11A, the user-operable controls 1100 and 1120 are in the form of keys or buttons. In particular, user-operable control 1100 is comprised of four buttons 1100a, 1100b, 1100c and 1100d, while user-operable control 1110 is comprised of two keys. It will be understood that the controls 1100 and/or 1120 may comprise of a number of keys or buttons that is greater than or less than that depicted here, and that the form of these keys or buttons may vary. Each key or button in the user-operable controls 1100 1120 is associated with a respective function that is activated when the button or key is pressed. It will be appreciated that other suitable types of user-operable controls may be provided for allowing a user to enter commands, such as a microphone connection to a speech-recognition unit and a touch-sensitive screen, amongst others.

In accordance with a specific example, the user control interface 118 enables a user to adjust the maintenance power level to a desirable level. In the example depicted, user operable controls 1120 are used to allow a user to manually modify the maintenance level of the sanitizing device 120 by increasing or decreasing the maintenance level currently in effect. The maintenance level currently in effect is conveyed via visual element 1130. It is to be appreciated in alternate embodiments, visual element 1130 and user operable controls 1120 may be embodied using different components. They may also be omitted in certain implementations and the functionality they provided may be alternatively provided through user-operable controls 1100 and display screen 1160.

In the example depicted in FIG. 11A, the interface 118 provides (via the display screen 1160) a menu-driven interface that allows the user to select the component(s) or functionality that he or she wishes. In this implementation, the function associated with a given button or key in the user-operable controls 1100 will be modified based on the information displayed on the display screen 1160.

In the non-limiting example shown in FIG. 11A, the display screen 1160 displays a menu list with the following elements/options:
Use Spa;
Test Water Quality; and
Other . . .

Each element or option in the menu list is aligned with a particular key or button in the user-operable controls 1100. In particular, the functionality or information associated with the aligned menu list element/option can be selected by actuating the particular key or button in the controls 1100. For example, in order for the user to use the bathing unit system 100, he or she may actuate the user-operable control 1100a. Similarly, in order for the user to test the water quality of the water within the receptacle 102, he or she may actuate user-operable control 1100b, and so on.

In certain embodiments, the actuation of one of the keys or buttons in the user-operable controls 1100 may select the element/option from the menu-driven interface displayed in the display screen 1160, but does not access the functionality and/or convey the information. In such cases, a user may use another control (such as the OK button depicted in FIG. 11A) to confirm that he or she wishes to access the functionality selected by one of the user-operable controls 1100. This division between the selection functionality provided by the user-operable controls 1100 and the confirmation functionality provided via the OK button may allow a user to avoid activating certain functionality of the sanitization system 160 by mistake.

In a specific example, when the user presses button 1100a associated with the menu item “Use Spa” shown in FIG. 11A, thereby indicating his/her intention to use the bathing unit, a signal is sent to the controller 150 indicating that the bathing unit system is in use. By providing such information to the controller 150, the amount of power supplied to the sanitizing device 150 can be adjusted based at least in part on usage information related to the bathing unit system 100.

Optionally, the menu driven interface of the control interface 118 may display information prompting the user to provide information related to a number of users of the bathing system to be displayed on the display screen 1160. By providing such information to the controller 150, the amount of power supplied to the sanitizing device 150 can be adjusted based at least in part on the number of bathers, as described with reference to FIG. 7b.

FIG. 11B depicts the control interface 118 following the activation of button 1100a in FIG. 11A. As shown by this figure, the user is presented with a set of selectable items enabling the user to specify the number of bathers for the bathing unit system. In the example shown, each selectable item presented by the menu-driven interface in the display screen 1160 corresponds to a particular number of bathers who will be using the bathing unit system 100 (e.g., 1 bather, 2 bathers, and so on). Alternatively, the options presented in the interface may correspond to numeric ranges of users, such as (but not limited to):
Less than 3 bathers;
3-6 bathers; and
More than 7 bathers.

By actuating a one of the user-operable controls 1100, the user can indicate to the sanitization system 160 the number of bathers who will be using the bathing unit system 100. This information is then transmitted to the controller 150 over communication link 1150. In this way, controller 150 may adjust the amount of power supplied to the sanitizing device based at least in part on the number of bathers indicated through the user interface 118.

In a non-limiting example of this functionality, assume that a user and two friends (i.e., three (3) people) plan to use the bathing unit system 100. To do this, the user accesses the control interface 118. Upon access, the interface 118 (via the display screen 1160) presents him or her with the menu-driven interface that is depicted in FIG. 11A. The user actuates the user-operable control 1100a that is aligned with the Use Spa function (i.e., the control 1100a) to select this item.

Upon actuation, the processing unit (not shown) displays the menu-driven interface that is depicted in FIG. 11B, which presents the user with selectable items enabling the user to specify the number of bathers for the system 100. As there will be three (3) bathers in total, the user actuates the “3 bathers” option from the menu, which in the embodiment depicted is aligned with the user-operable control 1100c. This information is conveyed by the user control interface 118 to the sanitizing device controller 150 via the communications link 1150. When the sanitizing device controller 150 receives this information, it manages the various components of the sanitizing system 160 based on the number of bathers using the bathing unit system 100.

In accordance with a specific example, the control interface 118 also allows a user to request that a test be conducted at to the water quality in the bathing unit system 100. In the example depicted in FIG. 11A, this functionality is made available through menu item “Test Water Quality” associated with key 1100b depicted in FIG. 11A. When a user actuates the key or button associated with this interface element (i.e., the user-operable control 1100b), a sanitizing device test process, such as for example the test described with reference to FIGS. 10A and 10B above, may be initiated by the sanitizing device controller 150. The results are then conveyed through display screen 1160.

In a non-limiting example, the control interface 118 includes a visual indicator 1110 for conveying whether the sanitizing device 120 is generating halogen (such as bromine). In a non-limiting example, the visual indicator 1110 includes a LED (Light-Emitting-Diode), which lights up when the electrolytic cell is producing bromine (when power is being supplied to the electrolytic cell) and is OFF when no bromine is being produced. Optionally, the visual indicator 1110 is configured to convey when the sanitizing device 120 cannot produce bromine due to an insufficient flow of water through the sanitization device 120. In a non-limiting implementation, the LED will blink if the processing unit 300 (shown in FIG. 3) determines that there is insufficient water flow (or no water) in the sanitization device and that the halogen generation has hence been interrupted.

The control interface 118 may also include a visual indicator for conveying information related to the level of halide salt in the water of the bathing unit system 100. In a specific example of implementation, the level of halide salt is determined during the process depicted in FIGS. 10A and 10B implemented by controller 150 and the information is sent from the controller 150 for display on the control interface 118. In a non-limiting example, the visual indicator includes a halide salt gage including a plurality or LEDs configured to indicate the level of halide salt in the water of the bathing unit system. Alternatively the halide salt gage may be displayed on the LCD screen 1160. The halide salt gage may be color coded to convey information as to a desired level of halide salt in the water. In a non-limiting implementation, a white zone indicates a low level of halide salt, a green zone indicates an optimal level of halide salt, a yellow zone indicate a slightly elevated level of halide salt and a red zone indicates a high (potentially hazardous) level of halide salt. The center of the green zone of the gauge is generally used to indicate an optimal level of halide salt. As halide salt is added to the water of the bathing unit system 100, and the process shown in FIGS. 10A and 10B is repeated, the gauge shifts to indicate the additional concentration of halide salt. Conversely as water is added to the bathing unit system, the gauge shifts to indicate a lower concentration of halide salt in the water.

The user control interface 118 may also include elements for visually conveying warning and/or error conditions related to the sanitizing device 120. These visual elements may be embodied using any suitable device including, but not limited to, LEDs and messages on LCD display 1160. A few examples of warning and error conditions that may be conveyed include:
“Low halide salt” error: this error is detected when the concentration of the halide salt in the water is below a certain threshold minimum halide salt level. This condition can be detected using the process depicted in FIGS. 10A and 10B, for example. In a non-limiting example of implementation, the user control interface 118 includes a “LOW SALT” LED indicator (not shown) which blinks when the “Low halide salt” error is present. Optionally, a maintenance guidance message may also be displayed on LCD display 1160 instructing the user to add halide salt to the bathing unit. An estimated amount of halide salt to be added may also be displayed in on the display screen 1160.
“High halide salt” error: this error is detected when the concentration of the halide salt in the water exceeds a certain threshold maximum halide salt level. Note that the “High halide salt” error could be the result of adding too much halide salt into the water or high TDS level (hardness, alkalinity, organic compounds, . . . ). This condition can be detected for example using the process depicted in FIGS. 10A and 10B. In a non-limiting example of implementation, the user control interface 118 includes a “HIGH SALT” LED indicator which blinks when the “High halide salt” error is present. Optionally, a maintenance guidance message may also be displayed on LCD display 1160 instructing the user to add fresh water to the bathing unit. An estimated amount of water to be added may also be displayed in on the display screen 1160.
“AC power” error: this error is detected when the sanitizing device 120 is not receiving adequate power from the power source 122 (shown in FIG. 1). This condition can be detected by controller 150 using any suitable mechanism and conveyed to the control interface. In a non-limiting example of implementation, the user control interface 118 includes a “AC power” LED indicator which blinks when the “AC power” error is present.

It will be appreciated in light of the present description that any suitable visual element may be used for conveying information related to the sanitizing device 120. In addition, it is to be appreciated that although the use of visual elements has been described in connection with the user control interface 118, one or more visual elements used for conveying information related to the sanitizing device 120 may be positioned in other suitable locations. For example, one or more visual elements may be located on a remote monitoring device in communication with controller 150 for example through interface 326 (shown in FIG. 3), on or near the housing 200 of the sanitizing device 120 (shown in FIG. 2) or in any other suitable location so that a user of the bathing unit system may be apprised of the operational status of the sanitizing device 120.

With reference to FIG. 11C, there is shown an alternative embodiment of the user control interface 118, which has been denoted as user control interface 118′ for the purpose of clarity. The interface 118′ includes a display screen 1182, a boost key 1184, a diagnostic key 1186, an up key 1187, a down key 1188 and a set of halide salt level indicators 1189.

The display screen 1182 is used to convey certain information regarding the sanitizing system 160 to the user. In the specific example shown, the display screen 1182 displays the current maintenance level of the sanitizing device 120.

The boost key 1184 allows the user to cause the sanitizing device 120 to acquire the boost mode. In response the controller 150 may interpret activation of the boost key as an indication that the bathing system is in use and would process this entry in accordance with the process described in FIGS. 7A and 7B. For example, the user may actuate the key 1184 to activate the boost mode for the device 120, while a subsequent actuation of this key may cause this device to return to the maintenance mode. Alternatively, the user may actuate the key 1184 to activate the boost mode for the device 120, and each subsequent actuation of this key would indicate an additional number of bathers up to a maximum number. The display screen 1182 may be configured such that when the boost key 1184 is pressed, the display conveys the number of times this key has been pressed and hence the number of bathers that are using the bathing unit. Alternatively, the number of bathers may be specified using the up and down keys 1187 and 1188.

The diagnostic key 1186 of the user control interface 118′ allows the user to cause controller 150 to perform a test on the sanitizing device, such as the one described with reference to FIGS. 10A and 10B. Display screen 1182 may be configured such that when the diagnostic key 1186 is pressed, the display conveys the results of the test performed.

The up key 1187 and the down key 1188 allow a user to enter and/or modify information that appears in the display screen 1182. In the specific example shown, the keys 1187 and 1188 can be used to respectively increase or decrease the maintenance level of the sanitizing device 120.

The halide salt level indicators 1189 allow a user to see the approximate concentration of halide salt currently within the water of the bathing unit system 100. In the specific example shown, the indicators 1189 include a plurality of LEDs configured to indicate the current concentration of halide salt within a range of incremented levels, such as level 1 to level 6. The indicators 1189 may also include an indicator that indicates when the halide salt concentration in the water is below the lowest incremented level (i.e., concentrations below level 1), as well as an indicator that indicates when this concentration is above the highest incremented level (i.e., concentrations above level 6).

It is to be appreciated that the examples of implementation of the user control interface 118 (118′) depicted in FIGS. 11A, 11B and 11C are specific examples and that many other implementations are possible and will become apparent to the person skilled in the art in light of the present description.

It is also to be appreciated that although the control interface 118 has been presented in the context of providing functionality to and/or conveying information specifically to or from the sanitization device 120, the control interface 118 may be configured for controlling operational settings for the entire bathing unit system 100 rather than just the sanitization device 120. In such alternative implementations, the control interface 118 would be in communication with the bathing unit system controller (not shown) for controlling the operational settings of the bathing unit. In such implementations, the display screen 1160 may display a menu-driven interface with options related to the other components of the system such as for example:
WATER TEMPERATURE/CIRCULATION
AUDIO/VIDEO
INTERNET/TELEPHONE
SANITIZATION

As before, actuating a key or button in the user-operable control 1100 aligned with the component may allow the user to access its associated functionality.

The elements/options for components of the sanitizing system 160 (such as the interface elements/options depicted within FIGS. 11A and/or 11B) in the menu-driven interface may be child element/options that are made accessible upon the subsequent actuation of one of the user-operable controls 1100 from a parent element/option. For example, upon user-actuation of the user-operable control 1100 adjacent to and aligned with the SANITIZATION interface element, access would be provided to the functionality of the sanitizing system 160 that was depicted previously in FIGS. 11A and 11B.

### Practical Example of Implementation

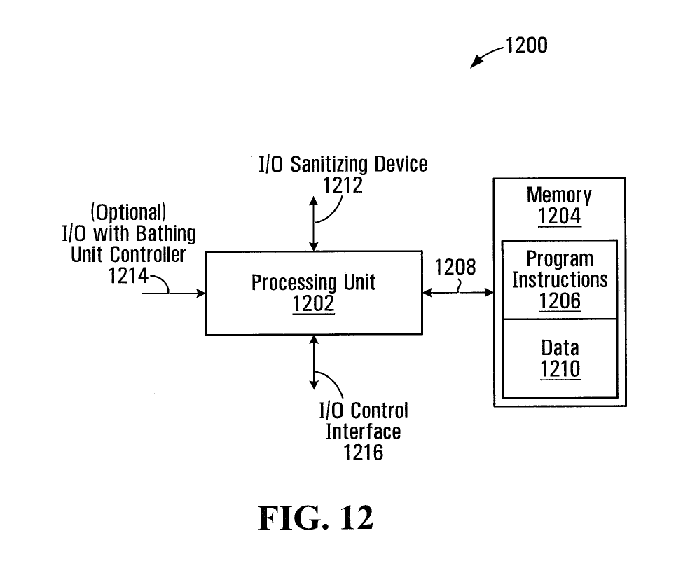

Those skilled in the art should appreciate that the sanitizing device controller 150, and more specifically the functionality of processor 300 which is depicted in FIG. 3, can be implemented on a suitable microprocessor 1200, of the type depicted in FIG. 12. Such a microprocessor 1200 typically includes a processing unit 1202 and a memory 1204 that is connected by a communication bus 1208. The memory 1204 includes program instructions 1206 and data 1210. The processing unit 1202 is adapted to process the data 1210 and the program instructions 1206 in order to implement the functional blocks described in the specification and depicted in the drawings.

The microprocessor 1200 may also comprise one or more I/O interfaces for receiving or sending data elements to external devices. In particular, the microprocessor 1200 comprises an I/O interface 1214 with the controller (not shown in the figures) of the bathing unit system 100 (shown in FIG. 1), an I/O interface 1212 for exchanging signals with the sanitizing device 120 and an I/O interface 1216 for exchanging signals with the user control interface 118 (and/or auxiliary control interface 119).

### Alternative Example of Implementation

In the above described example of implementation, the sanitizing device 120 is associated to a controller 150 dedicated to the sanitizing device 120. In alternative examples of implementation, some or the entirety of the functionality of the dedicated controller 150 may be incorporated in a controller configured to operate multiple devices, for instance in a controller configured for controller multiple bathing unit components in a bathing unit system.

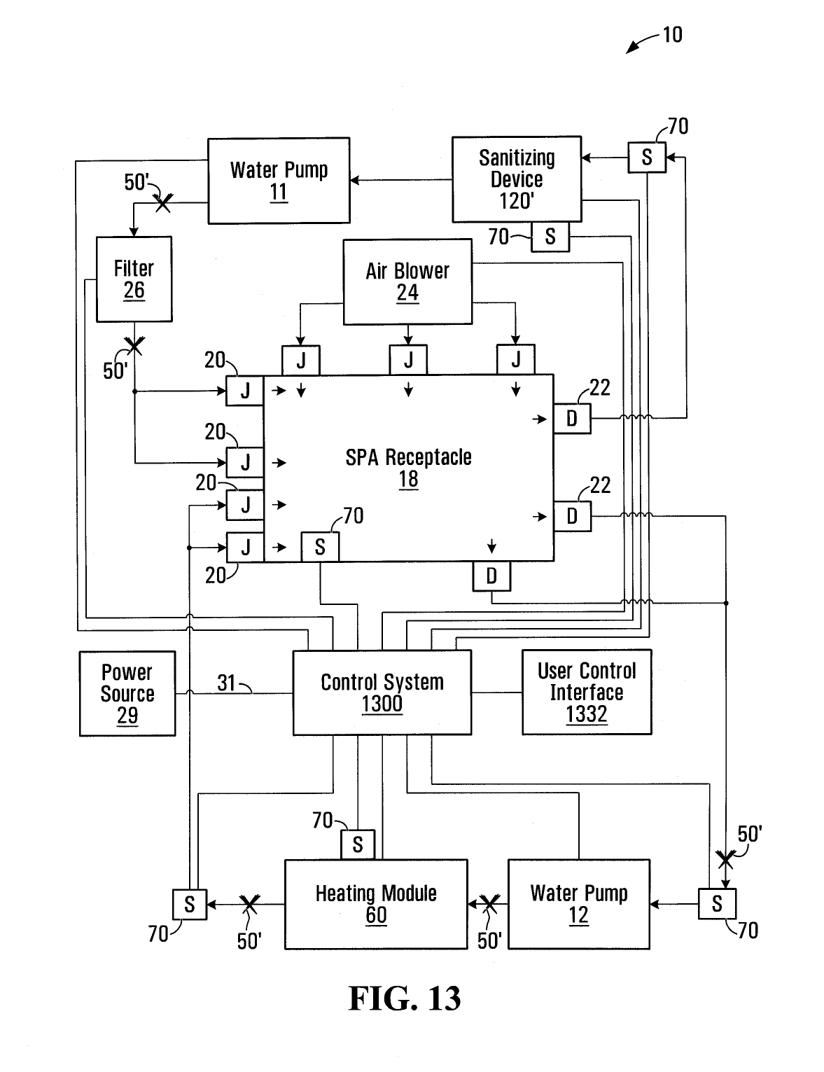

FIG. 13 illustrates a block diagram of a bathing unit system 10 incorporating an alternative specific example of implementation of the invention. As depicted, the bathing unit system 10 includes a bathing unit receptacle 18 for holding water, a plurality of jets 20, a set of drains 22, a heating module 60, two water pumps 11 & 12, a filter 26 and an air blower 24, and a control system 1300. It should be understood that the bathing unit system 10 could include more or less bathing unit components without departing from the spirit of the invention. The bathing unit system 10 also includes a user control interface 1332 for enabling a user of provide commands for controlling the operational settings of the components in the bathing unit system 10 and optionally for conveying information related to the bathing unit system 10 to the user. In this alternative specific example of implementation of the invention, sanitizing device 120 has been denoted by as sanitizing device 120′ for the sake of clarity but may be configured as sanitizing device 120 described with reference to FIG. 2. In this alternative example, the functionality for controlling the functioning of the sanitizing device 120′ is incorporated (in totality or in part) in control system 1300 configured for controlling operational settings in bathing unit system 10. Similarly the functionality of the control interface 118 (shown in FIG. 1) is incorporated (in totality or in part) in user control interface 1332.

In the example depicted, the sanitizing device 120′ is located in circulation piping of the bathing unit system 10 in fluid communication with water pump 11 and filter 26. It will be appreciated by the person skilled in the art that the sanitizing device 120′ may be located elsewhere in the circulation piping of the bathing unit system 10. Some examples of alternative locations for the sanitizing device 120′ have been identified with reference numeral 50′.

The above description of the embodiments should not be interpreted in a limiting manner since other variations, modifications and refinements are possible within the spirit and scope of the present invention. The scope of the invention is defined in the appended claims and their equivalents.

1. A sanitizing system for use in sanitizing water in a bathing unit system, the bathing unit system including a receptacle for holding water in which an halide salt has been dissolved and a circulating system for removing and returning water from and to the receptacle, the sanitizing system comprising:
a) a sanitizing device including:
i) a housing configured to be positioned in fluid communication with the circulation system for allowing water from the receptacle to flow through the housing; and
ii) an electrolytic cell positioned within the housing so that when power is applied to the electrolytic cell, the halide salt dissolved in the water flowing through the housing is converted to an amount of free halogen;
b) a controller configured for controlling an amount of power supplied to the electrolytic cell of the sanitizing device so as to control the amount of free halogen being generated, the controller adjusting the amount of power supplied to the sanitizing device at least in part based on use of the bathing unit system.

2. A sanitizing system as defined in claim 1, wherein the amount of power supplied to the electrolytic cell is adjusted at least in part based on an amount of use of the bathing unit system, wherein said controller is configured for:
i) receiving data conveying bathing unit usage information;
ii) adjusting the amount of power supplied to the electrolytic cell at least in part based on the received bathing unit usage information so as to adjust the amount of free halogen generated based in part on the amount of use of the bathing unit system.

3. A sanitizing system as defined in claim 2, wherein the circulating system of the bathing unit system includes a circulation pump, wherein the controller is configured for adjusting the amount of power supplied to the electrolytic cell at least in part based on usage of the circulation pump.

4. A sanitizing system as defined in claim 3, wherein the circulation pump can be activated and deactivated, wherein power is supplied to the electrolytic cell at least at a maintenance power level when the circulation pump is activated.

5. A sanitizing system as defined in claim 4, wherein the controller is configured for modifying the maintenance power level based is part on an amount of usage of the circulation pump.

6. A sanitizing system as defined in either one of claims 4 and 5, wherein the controller is configured for modifying the maintenance power level based is part on a water temperature associated with the water in the bathing unit system.

7. A sanitizing system as defined in any one of claims 2 to 6, wherein the controller increases the amount of power to be supplied to the electrolytic cell to a boost power level when the bathing unit usage information conveys that that the bathing unit system is being used by a bather.

8. A sanitizing system as defined in claim 7, wherein the controller is configured for determining a duration of time during which power is to be supplied to the electrolytic cell at the boost power level.

9. A sanitizing system as defined in claim 8, wherein the duration of time during which power is to be supplied to the electrolytic cell at the boost power level is determined at least in part based on the maintenance power level.

10. A sanitizing system as defined in claim 8, wherein the duration of time during which power is to be supplied to the electrolytic cell at the boost power level is determined at least in part based on a number of bathers in the bathing unit system.

11. A sanitizing system as defined in claim 2, wherein the bathing unit usage information conveys a number of bathers using the bathing unit system.

12. A sanitizing system as defined in claim 2, wherein the bathing unit usage information conveys an activation of a comfort bathing unit module in the bathing unit system.

13. A sanitizing system as defined in claim 12, wherein the comfort bathing unit module is selected from the set consisting of a jet pump, blower, a spa light and a heater module.

14. A sanitizing system as defined in any one of claims 2 to 13, wherein the bathing unit usage information is provided by a user of the bathing unit system through a user control interface, the control interface being in communication with said controller.

15. A sanitizing system as defined in claims 2 to 13, wherein said system further comprises a user control interface in communication with said controller.

16. A sanitizing system as defined in claim 15, wherein said user control interface is operative for enabling a user to enter information indicative of a desired change in a certain operational setting of the bathing unit system.

17. A sanitizing system as defined in any one of claims 14 to 16, wherein the user control interface includes an input for allowing a user to specify a number of bathers using the bathing unit system.

18. A sanitizing system as defined in any one of claims 14 to 17, wherein said control interface conveys information related to a condition associated with the sanitizing device.

19. A sanitizing system as defined in claim 2, wherein the power supplied to the electrolytic cell is a pulse width modulated power signal, said controller being configured for controlling the amount of power supplied to the electrolytic cell by varying a pulse width of the pulse width modulated power signal.

20. A sanitizing system as defined in any one of claims 1 to 19, wherein the halide salt includes elements selected from the set consisting of sodium chloride, sodium bromide and sodium iodide.

21. A sanitizing system as defined in any one of claims 1 to 19, wherein the halide salt includes sodium bromide.

22. A controller for controlling a sanitizing device for sanitizing water in a bathing unit system including a receptacle for holding water in which an halide salt has been dissolved, the sanitizing device being for positioning in fluid communication with a circulation system of the bathing unit system for allowing water from the receptacle to flow through the sanitizing device, the sanitizing device causing the halide salt dissolved in the water flowing there through to be converted to an amount of free halogen, the amount of free halogen generated being dependent on an amount of power supplied to the sanitizing device, said controller comprising:
a) an input for receiving data from a user control interface, the user control interface enabling a user to enter information related to the bathing unit system;
b) a processing unit in communication with said input, said processing unit controlling an amount of power supplied to the sanitizing device so as to control the amount of free halogen being generated, said processing unit adjusting the amount of power supplied to the electrolytic cell at least in part based on the information entered by the user at the user control interface.

23. A controller as defined in claim 22, wherein the amount of power supplied to the electrolytic cell is adjusted at least in part based on an amount of use of the bathing unit system, the amount of use of the bathing unit system being derived at least in part based on information entered at the user control interface.

24. A controller as defined in either one of claims 22 and 23, wherein the user control interface enables the user to enter information related to a number of bathers for the bathing unit system, said processing unit being responsive to information provided by the user and conveying the number of bathers for adjusting the amount of power supplied to the sanitizing device at least in part based on the number of bathers.

25. A controller as defined in claim 24, wherein the user control interface conveys information prompting the user to enter information related to the number of bathers for the bathing unit system.

26. A controller as defined in claim 25, wherein the user control interface presents the user with a set of selectable items enabling the user to specify the number of bathers for the bathing unit system.

27. A controller as defined in any one of claims 22 to 26, wherein said processing unit causes information related to a condition associated with the sanitizing device to be conveyed through the control interface.

28. A controller as defined in any one of claim 27, wherein the control interface includes visual elements for conveying information related to the condition associated with the sanitizing device.

29. A controller as defined in any one of claim 28, wherein the visual elements include at least one light-emitting diode (LED).

30. A controller as defined in any one of claim 28, wherein the visual elements include a display screen.

31. A controller as defined in any one of claims 22 to 30, wherein the halide salt includes sodium bromide.

32. In a bathing unit system having:
a) a receptacle for holding water in which an halide salt has been dissolved;
b) a circulating system for removing and returning the water from and to the receptacle; and
c) a sanitizing device for sanitizing water positioned in fluid communication with the circulation system for allowing water from the receptacle to flow through the sanitizing device, in use electrical power applied by device causing the halide salt dissolved in the water flowing there through to be converted to an amount of free halogen;
d) a user control interface for enabling a user to enter commands for controlling operational settings associated with the bathing unit system;
e) a controller for controlling operational settings associated with the bathing unit system, said controller comprising:
i) an input in communication with said user control interface;
ii) a processing unit in communication with said input, said processing unit:
i) controlling operational settings associated with the bathing unit system based on commands entered at the user control interface; and
ii) controlling an amount of power supplied to the sanitizing device so as to control the amount of free halogen being generated, the amount of power supplied to the electrolytic cell being adjusted at least in part based on use of the bathing unit system.

33. A controller as defined in claim 32, wherein the amount of power supplied to the electrolytic cell is adjusted at least in part based on an amount of use of the bathing unit system, the amount of use of the bathing unit system is derived at least in part based on the commands entered at the user control interface.

34. A controller as defined in claim 33, wherein said processing unit:
a) receives data conveying a water temperature associated with the bathing system;
b) controls operation of a heating device in the bathing unit system at least in part based on the water temperature;
c) adjusts the amount of power supplied to the sanitizing device based at least in part on the water temperature.

35. A controller as defined in claim 33, wherein the circulating system of the bathing unit system includes a circulation pump, wherein the processing unit:
a) causes the circulation pump to acquire an activated state and to acquire a deactivated state;
b) adjusts the amount of power supplied to the sanitizing device at least in part based on usage of the circulation pump.

36. A controller as defined in claim 35, wherein power is supplied to the sanitizing device at least at a maintenance power level when the circulation pump is in the activated state.

37. A controller as defined in any one of claims 32 to 36, wherein the user control interface enables the user to enter information related to a number of bathers for the bathing unit system, said processing unit being responsive to information provided by the user and conveying the number of bathers for adjusting the amount of power supplied to the sanitizing device at least in part based on the number of bathers.

38. A controller as defined in claim 37, wherein the user control interface conveys information prompting the user to enter information related to the number of bathers for the bathing unit system.

39. A controller as defined in any one of claims 32 to 38, wherein said processing unit causes information related to a condition associated with the sanitizing device to be conveyed through the control interface.

40. A controller as defined in any one of claims 32 to 39, wherein the halide salt includes sodium bromide.

41. A sanitizing system for use in sanitizing water in a bathing unit system, the bathing unit system including a receptacle for holding water in which an halide salt has been dissolved and a circulating system for removing and returning the water from and to the receptacle, the sanitizing system comprising:
a) a sanitizing device including:
i) a housing configured to be positioned in fluid communication with the circulation system for allowing water from the receptacle to flow through the housing; and
ii) an electrolytic cell positioned within the housing so that when power is applied to the electrolytic cell, the halide salt dissolved in the water flowing through the housing is converted to an amount of free halogen;
b) a controller configured for controlling an amount of power supplied to the electrolytic cell of the sanitizing device so as to control the amount of free halogen being generated, the controller:
i) receiving data conveying water temperature information; and
ii) adjusting the amount of power supplied to the electrolytic cell at least in part based on the water temperature information.

42. A sanitizing system as defined in claim 41, wherein said controller is configured for:
a) processing the data conveying water temperature information to derive a water temperature correction factor;
b) using the derived water temperature correction factor to adjust the amount of power supplied to the electrolytic cell.

43. A sanitizing system as defined in either one of claims 41 and 42, said system comprising a temperature probe for measuring a water temperature associated with the bathing unit system, said temperature probe being in communication with said controller.

44. A sanitizing system as defined in claim 43, wherein said temperature probe is positioned within the housing of the sanitizing device.

45. A sanitizing system as defined in claim 43, wherein said temperature probe is for positioning within the circulation system of the bathing unit system.

46. A sanitizing system as defined in claim 41, further comprising a user control interface in communication with said controller.

47. A sanitizing system as defined in claim 46, wherein said user control interface is operative for enabling a user to enter information indicative of a desired change in a certain operational setting of the bathing unit system.

48. A sanitizing system as defined in any one of claims 41 to 47, wherein said control interface conveys information related to a condition associated with the sanitizing device.

49. A sanitizing system as defined in claim 41, wherein the power supplied to the electrolytic cell is a pulse width modulated power signal, said controller controlling the amount of power supplied to the electrolytic cell by varying a pulse width of the pulse width modulated power signal.

50. A sanitizing system as defined in any one of claims 41 to 49, wherein the halide salt includes elements selected from the set consisting of sodium chloride, sodium bromide and sodium iodide.

51. A sanitizing system as defined in any one of claims 41 to 49, wherein the halide salt includes sodium bromide.

52. A method for sanitizing water in a bathing unit system, the bathing unit system including a receptacle for holding water in which an halide salt has been dissolved and a circulating system for removing and returning the water from and to the receptacle, said method comprising:
a) providing an electrolytic cell in a housing configured to be positioned in fluid communication with the circulation system for allowing water from the receptacle to flow through the housing, so that when power is applied to the electrolytic cell, the halide salt dissolved in water flowing through the housing is converted to an amount of free halogen;
b) controlling the amount of free halogen being generated by the electrolytic cell by adjusting an amount of power supplied at least in part based on use of the bathing unit system.

53. A method as defined in claim 52, wherein the amount of power supplied to the electrolytic cell is adjusted at least in part based on an amount of use of the bathing unit system, said method comprising:
i) receiving data conveying bathing unit usage information;
ii) adjusting the amount of power supplied to the electrolytic cell at least in part based on the received bathing unit usage information so as to adjust the amount of free halogen generated based in part on the amount of use of the bathing unit system.

54. A method as defined in claim 53, wherein the circulating system of the bathing unit system includes a circulation pump, said method comprising adjusting the amount of power supplied to the electrolytic cell at least in part based on usage of the circulation pump.

55. A device as defined in claim 54, wherein the circulation pump can be activated and deactivated, said method comprising supplying power to the electrolytic cell at least at a maintenance power level when the circulation pump is activated.

56. A method as defined in claim 55, said method comprising modifying the maintenance power level based is part on an amount of usage of the circulation pump.

57. A method as defined in either one of claims 55 and 56, said method comprising modifying the maintenance power level based is part on a water temperature associated with the water in the bathing unit system.

58. A method as defined in any one of claims 53 to 57, said method comprising for increasing the amount of power to be supplied to the electrolytic cell to a boost power level when the bathing unit usage information conveys that the bathing unit system is being used by a bather.

59. A method as defined in claim 58, said method comprising determining a duration of time during which power is to be supplied to the electrolytic cell at the boost power level.

60. A method as defined in claim 59, wherein the duration of time during which power is to be supplied to the electrolytic cell at the boost power level is determined at least in part based on the maintenance power level.

61. A method as defined in claim 59, wherein the duration of time during which power is to be supplied to the electrolytic cell at the boost power level is determined at least in part based on a number of bathers in the bathing unit system.

62. A method as defined in any one of claims 53 to 61, wherein the bathing unit usage information conveys a number of bathers for bathing unit system.

63. A method as defined in claim 53, wherein the bathing unit usage information conveys an activation of a comfort bathing unit module in the bathing unit system.

64. A method as defined in claim 63, wherein the comfort bathing unit module is selected from the set consisting of a jet pump, a spa light, a blower and a heater module.

65. A method as defined in any one of claims 52 to 64, wherein the power supplied to the electrolytic cell is a pulse width modulated power signal, said method comprising controlling the amount of power supplied to the electrolytic cell by varying a pulse width of the pulse width modulated power signal.

66. A method as defined in any one of claims 52 to 65, wherein the halide salt includes elements selected from the set consisting of sodium chloride, sodium bromide and sodium iodide.

67. A method as defined in any one of claims 52 to 65, wherein the halide salt includes sodium bromide.

68. A method for sanitizing water in a bathing unit system, the bathing unit system including a receptacle for holding water in which an halide salt has been dissolved and a circulating system for removing and returning the water from and to the receptacle, said method comprising:
a) providing an electrolytic cell in a housing configured to be positioned in fluid communication with the circulation system for allowing water from the receptacle to flow through the housing, so that when power is applied to the electrolytic cell, the halide salt dissolved in water flowing through the housing is converted to an amount of free halogen;
b) controlling the amount of free halogen being generated by the electrolytic cell by adjusting an amount of power supplied at least in part based a water temperature associated with the bathing unit system.

69. A sanitizing system for use in sanitizing water in a bathing unit system, the bathing unit system including a receptacle for holding water in which an halide salt has been dissolved and a circulating system for removing and returning water from and to the receptacle, the circulation system including a circulation pump, the sanitizing system comprising:
a) a sanitizing device including:
i) a housing configured to be positioned in fluid communication with the circulation system for allowing water from the receptacle to flow through the housing; and
ii) an electrolytic cell positioned within the housing so that when power is applied to the electrolytic cell, the halide salt dissolved in the water flowing through the housing is converted to an amount of free halogen;
b) a controller configured for controlling an amount of power supplied to the electrolytic cell of the sanitizing device so as to control the amount of free halogen being generated, the controller adjusting the amount of power supplied to the electrolytic cell at least in part based on usage of the circulation pump.

70. A sanitizing system as defined in claim 69, wherein the circulation pump can be activated and deactivated, wherein power is supplied to the electrolytic cell at least at a maintenance power level when the circulation pump is activated.

71. A sanitizing system as defined in claim 69, wherein the controller is configured for modifying the maintenance power level based is part on an amount of usage of the circulation pump.
